(19) United States
(12) Patent Application Publication
(10) Pub. No.: US 2015/0220942 A1
(43) Pub. Date: Aug. 6, 2015

(54) DATA COLLECTION AND REPORTING SYSTEM

(71) Applicant: Dale Dubberley, Vancouver (CA)

(72) Inventor: Dale Dubberley, Vancouver (CA)

(21) Appl. No.: 14/596,214

(22) Filed: Jan. 13, 2015

Related U.S. Application Data
(60) Provisional application No. 61/926,861, filed on Jan. 13, 2014.
(60) Provisional application No. 61/927,441, filed on Jan. 14, 2014.
(60) Provisional application No. 61/992,637, filed on May 13, 2014.
(60) Provisional application No. 62/063,629, filed on Oct. 14, 2014.

(51) Int. Cl. G06Q 30/02

(52) U.S. Cl. CPC G06Q 30/0201

(57) ABSTRACT

A computer-implementable method to track major financial metrics and the leading indicators of those metrics, including customer, employee and marketing metrics; to integrate those metrics into a data collection and dashboard reporting system; and to enable monitoring of key indicators of health of a business on a periodic basis.

A method and system of the present invention is provided to track major financial metrics (including customer, employee and marketing metrics) and the drivers of those metrics, and to integrate those metrics into a data collection and dashboard reporting system.

### BACKGROUND OF THE INVENTION

One challenge of business owners, particularly those with multiple locations is to track the health of each business independently and as a group in major areas of management.

Traditionally, business management systems rely on interpretation of large amounts of data from POS, sales, payroll and inventory management systems to analyze sales and profitability historically, without the ability to understand in detail how to influence changes in financial metrics. The primary drivers of those financial metrics are metrics that originate in the areas of customers, employee and marketing management.

Prior to this invention, management traditional accounting statements were used to understand the financial metrics of each business as a static number relative to last comparable period (eg: sales this quarter compared with sales last quarter or last year same quarter). This data was only available at a minimum 5-6 weeks after the period end and was primarily historical data. It allowed users to understand the financial results of a business's management, but not influence them or create financial changes in the accounting periods those financial results were created. Based on those reports, a user would set financial targets, but had no methodology for identifying and tracking the impact of specific actions that lead to the attainment of those financial results.

In particular, Small to Medium Enterprises (SMEs) are under a tremendous pressure to compete with big business. They need “big business technology” to provide business management insights in order to be competitive. Business intelligence (BI) and customer and employee engagement tools provide those insights, as a way to level the playing field.

BI is the set of techniques and tools for the transformation of raw data into meaningful and useful information for business analysis purposes. BI technologies are capable of handling large amounts of unstructured data to help identify, develop and otherwise create new strategic business opportunities. The goal of BI is to allow for the easy interpretation of these large volumes of data. Identifying new opportunities and implementing an effective strategy based on insights can provide businesses with a competitive market advantage and long-term stability.

There are some barriers to the adoption and use of BI methods and systems for SMEs. Most BI tools today do not encourage user engagement. Most mobile BI users are non-technical business people. While they want to consume and interact with information, they do not have the skill set to use sophisticated analytical tools to generate their own reports.

Customer and employee engagement tools allow the business to create 2 way communication channels that build relationships that result in increased loyalty. These engagement tools generate metrics that can feed back into BI reporting dashboards that can be used to predict and manage business outcomes.

On the “employee” side, employee engagement is the emotional commitment the employee has to the organization and its goals. This emotional commitment means engaged employees actually care about their work and their company i.e. they do not work just for a paycheck, or just for the next promotion, but work on behalf of the organization's goals. When employees care—when they are engaged—they use discretionary effort. This means, for example, that the engaged computer programmer works overtime when needed, without being asked. This means, for example, that the engaged retail clerk picks up the garbage on the store floor, even if the boss is not watching. This means, for example, that the airport security agent will pull a bag suspicious bag to be searched, even if it's the last bag on their shift, after a double shift. Engaged employees lead to better business outcomes. Studies have shown that companies with engaged workers have 6% higher net profit margins, and according to Kenexa research engaged companies have five times higher shareholder returns over five years.

So, employee engagement and positive business outcomes are correlated. Many studies show how engagement correlates to decreases in absenteeism, turnover, accidents, and defects, while it also correlates to increases customer satisfaction, service and operational standards, productivity, sales, and profits. The suggested causality is that engagement—the emotional commitment one has to their organization and its goals—drives higher levels of discretionary effort.

In spite of the impressive literature showing correlation between engagement and business outcomes, there is far less research showing connection or “causality”. So, the question is: “Maybe employees are just more engaged when their companies are growing, bonuses are big, and stock prices are climbing.”

A study published in the Journal of Occupational and Organizational Psychology¹ shows convincingly that, indeed, organizational commitment has more impact on business unit performance than vice versa. Researchers used both a longitudinal design and looked at the organizational commitment of 755 retail bank employees from 2005-2008, along with financial performance and customer satisfaction of the business units they worked in. Further, the study showed that indeed there is a reciprocal relationship between job attitudes and business performance within a one-year time frame, but when the time frame is increased to two or three years the correlation only remained in the direction of engagement preceding business outcomes. The researchers suggest: ¹ Journal of Occupational and Organizational Psychology Volume 85, Issue 3, pages 503-522, September 2012

Results indicated that organizational commitment had a more persistent influence on performance at the business unit level than vice versa. Consistent with prior research, this suggests that job attitudes may come first, and that practitioners might be well advised to aim to improve job attitudes in order to boost performance.

On the customer side, there is of course this same need for engagement, arguably even more so. Companies are constantly trying to determine the most profitable way to interact with their customer base. They have been trained to base their segmentation of customers off of statistics around prior communications and a perceived customer lifetime value. These traditional methods cannot provide insight into the level of engagement that the individual has with the company or brand. All companies are effectively looking for a way to measure the engagement levels of their customers so that they can form lasting relationships with these individuals maximizing the revenue potential from each of them.

Traditional methods that try to gather either or both of employee or customer engagement metrics but do not overlay this with other business analytic data. Traditional methods of data gathering and analytics, even if available, are cumbersome and expensive and largely outside of the reach of SMEs.

In summary, SME are at a disadvantage created by not having “big business” access to BI reporting methodology that can integrate traditional financial metrics and customer and employee engagement metrics, in order to manage and predict financial outcomes.

It is an object of the present invention to obviate or mitigate these disadvantages.

### SUMMARY OF THE INVENTION

It is an object of the invention to provide a customer engagement application generator which enables i) collection and aggregation of a plurality of customer engagement functions in regards to a business and ii) cross correlation of the customer engagement functions with at least one of sales and profitability metrics relating to the business and employee engagement metrics.

It is an object of the invention to provide an employee engagement application generator which enables i) collection and aggregation of a plurality of employee engagement functions in regards to a business and ii) cross correlation of the employee engagement functions with at least one of sales and profitability metrics relating to the business and customer engagement metrics.

The present invention provides a computer-implementable method for a business to create a customer engagement platform, for use on mobile computing devices.

The present invention provides a computer-implementable method for a business to create an employee engagement platform, for use on mobile computing devices.

The present invention provides a computer-implementable method to track major financial metrics and the leading indicators of those metrics, including customer, employee and marketing metrics; to integrate those metrics into a data collection and dashboard reporting system; and to enable monitoring of key indicators of health of a business on a periodic basis comprising:
a) acquiring customer data about a business in respect to at least one of customer satisfaction, number of times customer uses business, number of customer recommendations, length of time customer has used business, sales numbers, number of customers, average transaction size, customer experience rating, customer loyalty rating, product rating, service rating and business atmosphere rating (the “customer raw data”);
b) acquiring employee data about a business in respect to at least one of: employee satisfaction, number of times employees communicates, number of employee recommendations, length of time employee has been in the business, sales numbers, employee productivity metrics (ie. defined as a leading indicators of sales) employee customer service ratings, average customer transaction size, employee loyalty rating, and other user defined employee rating of the workplace and the business. (the “employee raw data”);
c) employing customer and employee application generators to create tools that collect a plurality of raw customer and employee data and engage both by email, text and mobile based applications.
d) processing, structuring, organizing and analysing the raw data, via a computer system, to generate data correlations and data relationships for the business and to define such data correlations and data relationships; and
e) visually displaying such data correlations and data relationships through management dashboards and customer and employee engagement platforms, for use on mobile computing devices.

The present invention provides, in another aspect, a method for to track major financial metrics and the drivers of those metrics, to integrate those metrics into a data collection and dashboard reporting system and to enable monitoring of key indicators of success of a workplace on a periodic basis comprising, comprising the steps of:
a) acquiring at least one real time, continuous, data point set relating to said workplace, which includes data points relating to all activities, roles and functions of a person within a selected time frame, (the “first data point set”);
b) measuring and comparing the first data point set against previously compiled data points from within that same or like workplaces and timeframes (the “comparable data point set”); and
c) utilizing differences and similarities between the first data point set and the comparable data point set to generate data correlations and data relationships for the business and to define such data correlations and data relationships; and
d) visually displaying such data correlations and data relationships.

The method and system of the present invention are provided to track major financial metrics and the drivers of those metrics, to integrate those metrics into a data collection and dashboard reporting system and to enable monitoring of key indicators of health of a business on a daily/weekly/monthly basis. The system comprises interfaces for simple data capture with optional interfaces to POS, customer survey, employee survey and other web based and/or tablet based software applications. The method produces visual charts and graphs with drill down capabilities that empower a user to understand and manage business trends interactively.

The present invention provides a computer-implementable method for a business to collect, track and analyze customer engagement metrics in relation to the business and the drivers of those metrics, to integrate those metrics into a data collection and dashboard reporting system and to enable monitoring of key indicators of health of a business on a periodic basis comprising:
a) acquiring data about a business in respect to at least one of: sales, customer loyalty, number of times customer uses business, number of customer recommendations, length of time customer has used business, sales numbers, number of customers, average transaction size, customer loyalty rating, product rating, service rating and business atmosphere rating (collectively “raw data”);
b) processing, structuring, organizing and analysing the raw data, via a computer system, to generate data correlations and data relationships for the business and to define such data correlations and data relationships; and
c) visually displaying such data correlations and data relationships.

The present invention provides a computer-implementable method for a business to collect, track and analyze employee engagement metrics in relation to the business and the drivers of those metrics, to integrate those metrics into a data collection and dashboard reporting system and to enable monitoring of key indicators of health of a business on a periodic basis comprising:
a) acquiring data about a business in respect to at least one of; employee survey metric; employee loyalty rating, customer service rating, workplace rating, support rating, employee productivity and incentive metrics (the “employee raw data”);
b) processing, structuring, organizing and analysing the employee raw data, via a computer system, to generate data correlations and data relationships for the business and to define such data correlations and data relationships; and
c) visually displaying such data correlations and data relationships.
The present invention provides a computer-implementable method for collecting and analyzing data and generating recommended actions for a business on a periodic basis comprising:
a) acquiring data, in sets, for the business including at least one of: data of one year to previous year, data on actual vs target, data around a selected time trend (for example 6 week trend), (collectively, the “data sets”);
b) analyzing the condition of the company based on relationships of data in data sets (“data analysis”);
c) collecting a set of company “condition statements” (for example, at Main Street location, customer service rating is down in the area of “product knowledge”);
d) mapping the data analysis to the set of company “condition statements;
e) mapping the condition statements to one or more recommended action statements (for example, staff training session on product knowledge is recommended); and
f) delivering and visually displaying condition statements and actions statements on a mobile or personal computing device using a personalized “avatar”.

The present invention further provides a system comprising: one or more processors; a customer engagement system configured to receive, from a plurality of channels, data representing one or more interactions with a customer of a business (customer data); and a correlation module executable by the one or more processors and configured to: determine any secondary characteristics from the customer data; and generate data correlations and data relationships for the business between the customer data and at least one of sales metrics of the business profitability metrics of the business.

The present invention further provides a system comprising: one or more processors; an employee engagement system configured to receive, from a plurality of channels, data representing one or more interactions with an employee of a business (employee data); and a correlation module executable by the one or more processors and configured to: determine any secondary characteristics from the employee data; and generate data correlations and data relationships for the business between the employee data and at least one of sales metrics of the business profitability metrics of the business.

A customer engagement application generator which enables a business user to collect and aggregate a plurality of customer engagement functions in regards to the business comprises at least one text selection module, at least one colour selection module and at least one image upload module. Optionally, the customer engagement application generator comprises of a survey link that can be used independent of the customer engagement application.

The present invention further provides an apparatus comprising:
a memory; and
a processing device communicably coupled to the memory and to:
receive a request to create a customer engagement application, the request comprising specific application information and specific content for the customer engagement application;
generate a customer engagement application description based on the specific application information, wherein the application description comprises a selection of one or more application features for the customer engagement application;
enable access and use of the customer engagement application by a user on a computing device.

The present invention further provides an apparatus comprising:
a memory; and
a processing device communicably coupled to the memory and to:
receive a request to create an employee engagement application, the request comprising specific application information and specific content for the employee engagement application;
generate an employee engagement application description based on the specific application information, wherein the application description comprises a selection of one or more application features for the employee engagement application;
enable access and use of the employee engagement application by a user on a computing device.

The present invention further provides a cloud-based customer engagement platform which receives customer engagement metrics in relation to a business and drivers of those metrics, which integrates those metrics into a data collection and dashboard reporting system, viewable and alterable by the business and which enables monitoring of key indicators of health of the business on a periodic basis, wherein platform:
a) acquires data about a business in respect to at least one of: sales, customer loyalty, number of times customer uses business, number of customer recommendations, length of time customer has used business, sales numbers, number of customers, average transaction size, customer loyalty rating, product rating, service rating and business atmosphere rating (collectively “raw data”);
b) processes, structures, organizes and analyses the raw data to generate data correlations and data relationships for the business and to define such data correlations and data relationships; and
c) visually displays such data correlations and data relationships on the dashboard.
The present invention further provides a cloud-based employee engagement platform which receives employee engagement metrics in relation to a business and drivers of those metrics, which integrates those metrics into a data collection and dashboard reporting system, viewable and alterable by the business and which enables monitoring of key indicators of health of the business on a periodic basis, wherein platform:
a) acquires data about a business in respect to at least one employee survey metric; (the “employee raw data”);
b) processes, structures, organizes and analyses the employee raw data to generate data correlations and data relationships for the business and to define such data correlations and data relationships; and
c) visually displays such data correlations and data relationships on the dashboard.

The present invention further provides a computer-readable storage medium having computer-executable code encoded therein for collecting, analyzing, comparing and displaying a first data point set and comparable data point sets, as noted above.

The method and system of the present invention:
Define the “drivers”, or specific actions for increasing sales and profitability
Enable an understanding of the relationship between the driver for success metrics and the financial results
Provide a visually based management system that tracks the trends of financial metrics and drivers of success metrics on a weekly basis
Correlate the data between the sets of metrics (e.g. Sales & profitability, the customer experience, customer retention statistics, the employee experience, market intelligence and feedback on marketing/promotion initiatives)
Develop tools for data capture on a daily/weekly/monthly basis in each metric
Design simple, easily interpreted reports that illustrated a cause and effect relationship between specific employee actions, the drivers of success and the financial results.
This cause & effect feedback loop allowed for changes in behaviour on a weekly basis, resulting in attainment of realistic financial targets
A feedback loop was created to understand the customer experience and respond to them
A formula was devised to calculate an employee productivity ratio that established between financial and driver metrics (e.g. Customer satisfaction ratings, # of promotion actions, etc.) and employee reward systems that incentivized employees to be accountable for targeted results and take ownership of them
A system was devised to attributing reward points and an accounting system for tracking points earned and points redeemed.
A reporting method that allowed a “drill down” from a major financial metric (e.g. Sales) to a specific actionable item (e.g. Change the plate size and analyze cost of goods sold on a specific menu item).
The ability to identify a specific action and holding employees accountable for the completion of this action, resulted in a direct correlation with sales and profitability increases.

The method and system of the present drives business success by providing tools to track and interpret key metrics that answer questions such as: How is my business doing overall? Do customers like what I'm doing? What impact are my employees having on my customers? What impact are my customers having on my employees? How can I interpret feedback from both customers and employees and create useful, trackable analytics from that feedback? Are my marketing programs delivering what I want? How are my sales margins? What is my marketing ROI? What are my inventory turns? How are my labour efficiencies? What impacts my labour efficiencies? How are my community contributions and sustainability policies affecting my customer and employee loyalty? How can I keep pushing up my sales, profitability and long term business viability by what I do each week in regards to my customers and my employees?

In one aspect of the invention, there is provided a means to create, use and gather data from an employee engagement platform, ultimately to understand causation between employee attitude and business outcomes. By way of this platform, it is possible to explore the relationship between the regular and direct access of employee performance metrics to the employees, resulting in increased feelings of control in the workplace and accountability for business outcomes. By way of this platform, it is possible to explore the role of regular acknowledgement of employee successes on sustaining excellence in employee performance and team morale, regardless of business growth rates. By way of this platform, it is possible to understand the impact of tools that increase the frequency of communications between employees and between employees and management on the cohesiveness of the team, team productivity and resulting increases in operational efficiencies.

The method and system of the present invention provides simple, visual business intelligence reporting systems with daily, weekly, monthly updates that encompasses a customer and employee engagement metrics, optionally aggregated with sales and financial metrics (for example, sales, margins, inventory, customer experience, employee experience, employee productivity and incentives, promotions, social marketing, financial ratios, community contributions and sustainability management).

The method and system of the present invention develops industry specific data capture interface applications that have multiple functionality (e.g. Customer interfaces—Data capture, GPS business locator and quick contact links to phone, map, hours, and reviews, marketing messaging, rewards programs, coupon generation and tracking, customer and management data alerts and mobile ordering).

The method and system of the present invention educates business owners on the direct link between customer and/or employee engagement and other sales and business metrics and data correlations that enable them to drive sales and profitability.

The method and system of the present invention provides small business owners with a marketing return on investment metric (ROI metric) that can be used to increase their sales by then using it to evaluate and improve marketing effectiveness.

The method and system of the present invention provides small business owners with the ability analyze the data presented on customers, employees, marketing in relation prior year, target and selected time (for example, 6 week) trends to create a strategy and specific list of actions for increasing sales and profitability.

The method and system of the present invention empowers small business owners with data capture and data visualization tools to manage trends interactively with direct cause and effect feedback on actions (e.g. a social marketing coupon created an increase in # of customers and increase in average transactions which increased sales by %).

The method and system of the present invention minimizes the time, knowledge and investment required to work with BI technology, with simple customization options requiring no IT, accounting or systems knowledge (ie. data labeling without changes in BI reporting structure and programming support). It also enables a BI integrated “view” of the entire company and not just pieces.

A method and system of the present invention consolidates all the information a user needs into single mobile tool to manage one or multiple locations providing, in one aspect an “at a glance” control over key business management metrics.

The method and system of the present invention were devised to track the key indicators of health of a business. The system creates a direct link from a major financial metric to specific driver of that metric, and provides the level of detail as to specific impact of each driver.

Small businesses typically don't have the IT knowledge or budgets to create integrated business intelligence system that can be customized to their business. The multi-function, integrated customer and employee engagement programs that feed market and customer and employee intelligence into business intelligence backend typically require IT support, graphic designers and web programmers define, create, administer, create engagement centres, publish content, distribute & track coupons, and provide other graphics content. The feedback loop to gather business analytics intelligence that feeds into a comprehensive management methodology is cost prohibitive and typically beyond the scope of knowledge of most small business owners and support staff.

Business owners typically want to generate a list of actions that lead to increased sales and profitability based on the metrics gathered, tracked and reported. A business owner with multiple locations may have too many metrics to analyze on a meaningful (for example weekly) basis. For example, a business with 10 locations and each location with 50 metrics, would need to look at 500 metrics weekly to keep on top of the business.

One method of the invention (the “management method”) enables an analysis of the inter-relationships of customer, employee and marketing metrics in relationship to sales and profitability. The condition of the company can be analyzed by comparing data this year to last; actual vs target; and as a selected time (for example 6 week) trend. Based on the analysis, company “condition statements” can be generated (e.g. your Main Street location customer service rating is down in the area of product knowledge) and mapped to a set of “recommended actions” (e.g. recommend a staff training session on product knowledge), that are delivered to a personal device.

Currently there are no methods or tools that can generate a list of action statements and recommendations based on the analysis of metrics that include sales, margins, inventory, customers, employee, marketing, and community impact.

Currently there are no methods or tools to cost effectively create custom branded, multi-function customer and employee engagement center that offers consumer participation in product development, social marketing recruitment, promotions coupons generation, on-line shopping, location information, NPS and customer and employee experience survey technology in a single interface and integrative approach that can reside on a consumer personal device or in-store kiosk.

### BRIEF DESCRIPTION OF THE DRAWINGS

The following figure sets forth embodiments in which like reference numerals denote like parts. Embodiments are illustrated by way of example and not by way of limitation in all of the accompanying figure in which:

FIG. 1—is a graph set illustrating that the Primary Driver of Sales down trend is the # of Customers;

FIG. 2—is a graph set illustrating that the Primary Driver of # of Customers downtrend is Customer Loyalty metric;

FIG. 3—Primary Driver of Customers Loyalty downtrend is the Price metric;

FIG. 4—Customer Loyalty ratings and feedback;

FIG. 5—Overview of sample drill down sequence & resulting specific actions;

FIG. 6 is a block diagram of a network architecture 100 in which embodiments of a mobile application generator may operate;

FIG. 7 is a diagram of DRIVE™ Management System Data Sources;

FIG. 8 is a diagram of a sample setup screen showing how customer can custom brand and customize the management system without a web programmer;

FIG. 9 is a diagram of a sample weekly manual input screen;

FIG. 10 is a sample Visual Dashboard Output;

FIGS. 11A and 11B are comparative overview snapshots with gas gauge, bar charts and pie charts and comparative trend charts with tables for color coded % of targets with comparative data tables;

FIG. 12 is a dashboard showing employee satisfaction metrics being cross correlated to customer satisfaction metrics & community metrics;

FIGS. 13A and 13B is a dashboard showing sample Customer Survey Setup Screens;

FIGS. 14A and 14B is a dashboard showing sample Customer Survey Screens;

FIGS. 15A, 15B, 15C and 15D is a dashboard showing sample Customer Survey Output;

FIGS. 16A and 16B is a dashboard showing sample Customer Engagement App Setup Screens;

FIG. 17 is a dashboard showing sample mobile interfaces

FIGS. 18A and 18B is a dashboard showing sample employee interface;

FIGS. 19A and 19B is a dashboard showing further employee interface screens on a mobile device;

FIGS. 20A, 20B and 20C is a dashboard showing a sample employee survey dashboard interface;

FIGS. 21A and 21B is a dashboard showing employee overview dashboard interfaces;

FIG. 22 is a dashboard showing sample employee productivity dashboard interface;

FIG. 23 is a dashboard showing a sample team reward dashboard interface;

FIGS. 24A and 24B is a dashboard showing sample promotions data interfaces;

FIG. 25 is a dashboard showing sample weekly promotions dashboard interfaces;

FIG. 26 is a dashboard showing sample weekly promo trends; and

FIG. 27 is a dashboard showing sample drill down flowchart based on weekly metrics.

### PREFERRED EMBODIMENTS OF THE INVENTION

A detailed description of one or more embodiments of the invention is provided below along with accompanying figures that illustrate the principles of the invention. As such this detailed description illustrates the invention by way of example and not by way of limitation. The description will clearly enable one skilled in the art to make and use the invention, and describes several embodiments, adaptations, variations and alternatives and uses of the invention, including what we presently believe is the best mode for carrying out the invention. It is to be clearly understood that routine variations and adaptations can be made to the invention as described, and such variations and adaptations squarely fall within the spirit and scope of the invention.

In other words, the invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Similar reference characters (if any) denote similar elements throughout various views depicted in the figures.

In the present disclosure and claims, the word “comprising” and its derivatives including “comprises” and “comprise” include each of the stated integers but does not exclude the inclusion of one or more further integers. The term track and channel may be interchanged herein.

The term “variation” of an invention means an embodiment of the invention, unless expressly specified otherwise. A reference to “another embodiment” or “another aspect” in describing an embodiment does not imply that the referenced embodiment is mutually exclusive with another embodiment (e.g., an embodiment described before the referenced embodiment), unless expressly specified otherwise.

The term “including” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

The term “employee raw data” refers to data, about a business, in respect to at least one of; employee survey metric; employee loyalty rating, customer service rating, workplace rating, support rating, employee productivity and incentive metrics.

This description of preferred embodiments is to be read in connection with the accompanying drawings, which are part of the entire written description of this invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

The method of the present invention may be implemented on any computing device including on a mobile device. The term “mobile device” refers herein to any personal digital assistants, Smart phones, other cell phones, tablets and the like.

Described herein are systems and methods to track major financial metrics (including, but not limited to, customer, employee and marketing metrics) and the drivers of those metrics, and to integrate those metrics into a data collection and dashboard reporting system, viewable by a user on a computing device, including a mobile device such as a tablet or Smartphone.

One aspect of this invention provides a system and method for “quantifying” customer engagement which businesses can use (optionally) along with a view into recent customer transactional history to identify engagement metrics within their customer base and to then correlate these engagement metrics with sales and profitability metrics.

Another aspect of this invention provides a system and method for “quantifying” employee engagement which businesses can use to identify engagement metrics within their employee base and to then correlate these engagement metrics with sales and profitability metrics.

Another aspect of this invention provides a system and method for analyzing data to generate “action lists” which if applied by the business, can lead to increased sales, profitability and long term business viability.

The systems and methods (including the engagement application generator) described herein provide companies the ability to not only focus on the interactions they are having with their customers but in addition be aware of how their customers are portraying the accounts of these interactions to others and to then correlate all such metrics to sales and profitability metrics. The expansion of social networks and online forums has made it desirable for companies to look outside of their private domain and be fully aware of the conversations that are taking place which will affect their bottom line. Power has shifted to the consumer making it very desirable for companies to identify who their largest promoters are and to cultivate a relationship with these individuals that will lead to them promoting the brand to their friends, family, and business contacts.

The use of timing around customer interactions is also desirable when determining engagement, but not considered in traditional approaches. If a consumer is not continually engaging with the brand then the overall number of transactions is meaningless. This is an area where traditional engagement calculations typically fall short as they do not properly weigh the historical vs. recent timestamp associated with various transactions.

The method and system of the present invention is a LAN and/or cloud based business intelligence system that tracks the key indicators of health of a business and reports on those trends with visual trend and relative data analysis tools. The system correlates data about the primary drivers of business success to assist the user in identifying and increasing actions that lead to increases in sales, profitability, and long term sustainability and growth.

It is a system of customer and employee engagement, that is pro-active in nature with data correlations that a focus on cause and effect relationships, as opposed to passive historical analysis that is primarily static in nature. It includes accountability measures that overlay best practices disciplines onto employees and management teams as a by-product of data and trend analysis.

The system includes drill down capabilities to understand how the drivers of success are influencing end financial results and insight into how to maximize each contributor to increase positive impact or decrease negative impacts on financial metrics.

The integrated business analytics and management method of the present invention aggregates leading and lagging indicators of business success and cross correlates data across a multiple functional areas to identify relationships and algorithms that lead to increases in sales and profitability. These metrics include sales, margins, inventory, customer, employee, marketing, social marketing and community impact data.

The analysis of these metrics based on the management method can result in a set of condition statements and recommended action statements being generated for the business.

In a preferred form, two links are generated from the “Customer Engagement Application Generator” of the present invention:
1) a web-based customer engagement application link that can be installed as an icon and loaded from the home screen of a consumers' mobile device. Most preferably, it includes a survey function within the application; and
2) a link to a customer survey that can be deployed outside and independent from the engagement application.

Whether deployed through the engagement app or as a direct survey link, customer survey data is gathered and displayed in the visual reporting dashboard system, as described in further detail herein.

Mobile Application Generator

A method and system for automated application generation is described herein. In the following description, numerous details are set forth. It will be apparent to one of ordinary skill in the art having the benefit of this disclosure, that examples of the present teachings may be practiced in the absence of these specific details. In some instances, well-known structures and devices are shown in block diagram form instead of in detail in order to avoid obscuring the examples of the present teachings.

The examples described herein may provide an automated mobile application generator (also referred to herein as a mobile app generator). The mobile app generator may be used to create and publish customized mobile applications (also referred to herein as mobile apps). These mobile apps may be generated for small, medium or large businesses/entities, who may be vendors of various products or services.

Hereinafter these vendors/businesses may be referred to interchangeably as providers. Those serviced by these providers are referred to as consumers or customers. These providers may distribute the mobile apps to their respective end-user consumers for use on mobile devices.

Mobile applications, also called mobile apps or apps, are software applications, usually designed to run on Smartphones, tablet computers, and other handheld devices.

They can be native apps that are available through application distribution platforms, which are typically operated by the owner of the mobile operating system, such as the Apple® App Store, Android® Market, and BlackBerry® App World. Some mobile apps are free, and others may have a price. Usually these mobile apps are downloaded from the platform to a target device such as to one of the iPhone®, BlackBerry®, or Android® phones. Alternatively, they can be downloaded to other types of computers such as a tablet, laptops or desktops.

They can be also be web-based apps that are not available through application distribution platforms, but are deployed and distributed through business owner channels, such as social marketing platforms like Facebook and Twitter, as a link on the company website, by email, via in-house signage with scannable QR codes. An icon can is typically installed on the target device such as to one of the iPhone®, BlackBerry®, or Android® phones. Alternatively, they can be downloaded to other types of computers such as a tablets, laptops or desktops.

So, in one aspect, engagement centres are “web-based” applications. Web based applications allow a business to control the distribution of the app links in a communication environment that is dedicated to the business. In this case, it is not listed with other apps in a competitive environment like Apple app platform.

Mobile apps were originally intended for productivity: e.g., email, calendar and contact databases, however, public demand caused rapid expansion into other areas such as mobile games, factory automation, global positioning systems (GPS) and location-based services, banking, order-tracking, and ticket purchases, and the like. Mobile application development is the process by which application software is developed for handheld devices such as personal digital assistants, enterprise digital assistants or mobile phones. These mobile applications may be either pre-installed on phones during manufacture, may be downloaded by consumers from various mobile software distribution platforms, or may be web applications delivered over HTTP which use server-side or client-side processing (e.g. JavaScript) to provide an “application-like” experience within a Web browser. Android®, iOS®, BlackBerry@, HP WebOS®, Symbian® OS, and Windows Mobile® operating systems support application binaries as found on personal computers with code which executes in the native machine format of the processor. Platforms for mobile applications also may have an integrated development environment that provides tools to allow a developer to write, test, and deploy applications into the target platform environment.

Typically, a software developer writes application software for an application provider for a specific task to be executed on a certain platform or operating system. If a second application provider desires to be able to offer the same mobile application, the software developer manually customizes the mobile application to reflect the second application provider. If a provider desires a mobile application to present one view of a certain function to a consumer and a second view to the provider, the software developer manually generates two different applications. As such, the manual process for generating mobile applications can be both costly and time consuming.

Within one aspect of the present invention, there is provided a method and system for automated application generation, said applications specifically enabling i) collection and aggregation of a plurality of employee and/or customer data in regards to a business and ii) cross correlation of the employee and/or customer engagement functions with at least one of sales and profitability metrics relating to the business.

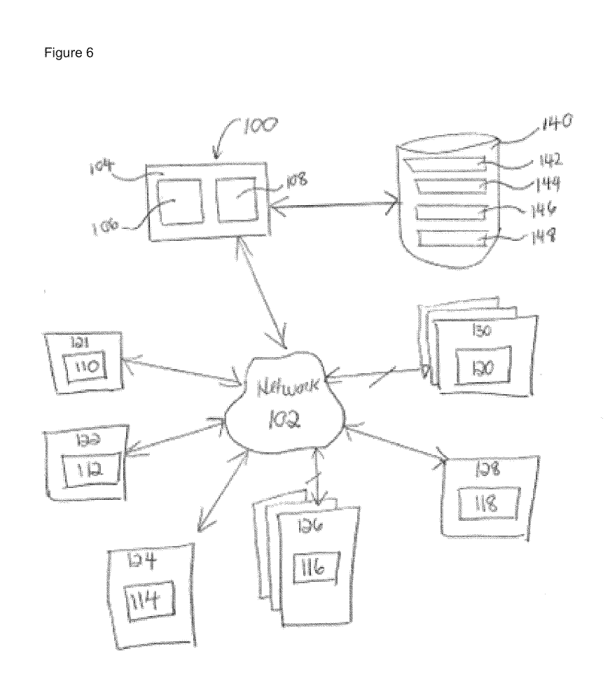

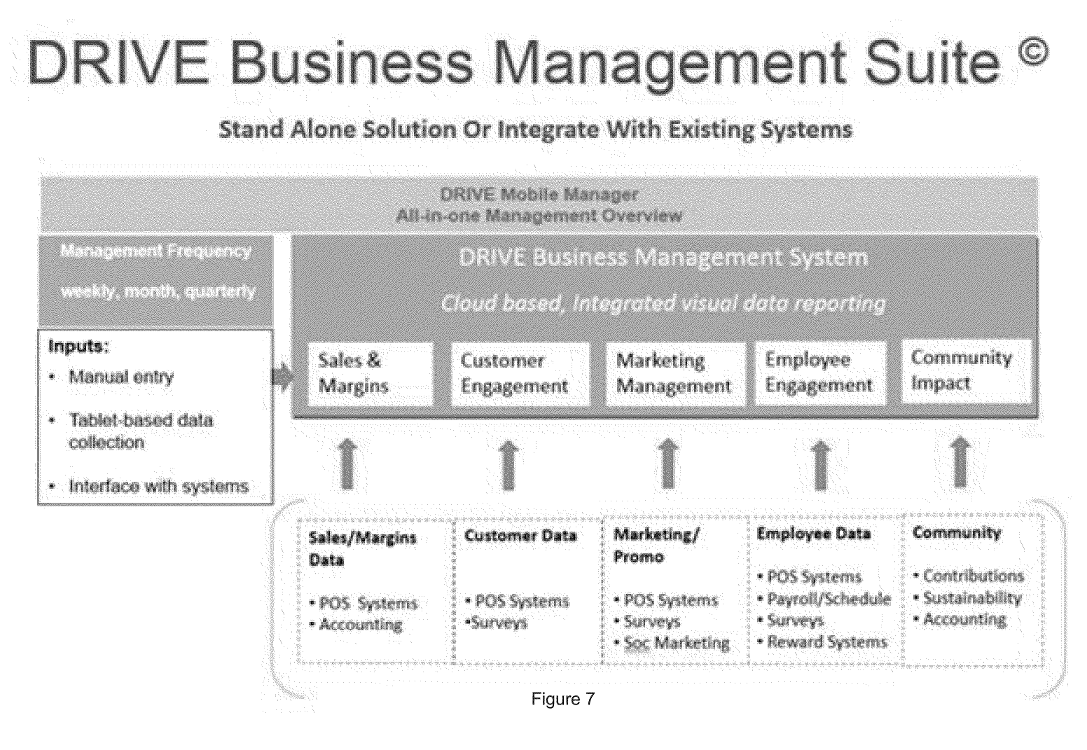

In operation, by way of illustration, FIG. 6 is a block diagram of a network architecture 100 in which embodiments of a mobile application generator may operate. In the depicted embodiment, a server computing system 104 includes an application generation server 106 and an application programming interface (API) application server 108. The server computing system 104 may interact with mobile apps, e.g., provider console 110, admin console 112, provider “A” app 1 114, consumer app 1 116, provider “B” App 2 118, and consumer app 2 120. The mobile apps generated by the server computing system 104 may have two separate components, a server-side component and a client-side component. The network architecture 100 may include multiple client computing systems (referred to herein as device 1 121, device 2 122, provider “A” mobile device 3 124, provider “A” mobile device 4 126, provider “B” mobile device 5 128, and provider “B” mobile device 6 130, collectively referred to herein as “consumer computing systems”) that may be coupled to the server computing system 104 via a data communications network (e.g., network 102) which may include a public network such as the Internet or private network such as a local area network (LAN).

The provider console 110 and the admin console 112 can be graphical user interfaces (GUIs) or other user interfaces that access the server computing system 104, such as a browser or any device that can access the consoles. The provider console 110 and the admin console 112 may serve two different functions. In one embodiment, the provider console 110 enables a provider or a vendor to communicate with the server computing system 104 to submit and configure input for the generation of their mobile app and to monitor the mobile app generation process. The admin console 112 enables an administrator or operator of the server computing system 104 (or the application generation server 108 and API application server 106) to communicate with the server computing system 104 to perform administrative tasks such operations, maintenance and provisioning.

The network architecture 100 may also include one or more content repositories, illustrated as data storage 140. The data storage 140 may be a content repository in which application templates 142, provider data 144, applications 146, and forms 148 may be stored. The application templates 142 may be a mobile application design template for creating a mobile app. Such template may include, for example, a certain area to include a logo, another area to include a photo, and a third area to include a company name and description. Provider data 144 may include, but is not limited to, provider-specific application information that is such as the business name, address, contact number, and the like. Applications 146 may include the generated mobile apps that are customized for the provider. Forms 148 may include different types of documents with blank fields for the insertion of details or information.

In other examples, the network architecture 100 may include other devices as would be appreciated by one of ordinary skill in the art having the benefit of this disclosure. In one example, the data storage 140 may include a core data store and engine. The core data store and engine may be configured to store data, preferences, recommendations as well as the interactions (both consumer and employee) as described herein.

The network 102 may include the Internet and network connections to the Internet. Alternatively, the server computing system 104 and the consumer computing systems may be located on a common local area network (LAN), personal area network (PAN), campus area network (CAN), metropolitan area network (MAN), Wide area network (WAN), wireless local area network, cellular network, virtual local area network, or the like. Examples of the consumer computing systems may include a consumer workstation, a server, a computer, a portable electronic device, an entertainment system configured to communicate over a network, such as a set-top box, a digital receiver, a digital television, a mobile phone, or other electronic devices. For example, portable electronic devices may include, but are not limited to, cellular phones, portable gaming systems, portable computing devices, or the like. The consumer computing systems may have access to the Internet via a firewall, a router, or other packet switching devices. The server computing system 104 may be a network appliance, a gateway, a personal computer, a desktop computer, a workstation, etc.

In one example, an automated app generator can include the server computing system 106 which can include the application generation server 108 and the application server 109. The serving computing system 106 may provide a provider portal (e.g., provider console 112), which may be a web front-end, such as a web-based interface, where the provider-specific application information can be entered and a feature tier can be selected. The provider portal may enable providers to customize the mobile app to be generated, such as to enter their business information, generate deals, manage their schedules and create alerts as described herein. The provider portal may provide an interface with most of the other back end components and help orchestrate and visualize the status of the different operations. This component may also be hosted by other servers, such as a third-party server.

In one embodiment, a provider can select, input, or otherwise specify configuration details of the mobile app via the provider console 110. The feature tier may indicate which features can be enabled for this particular mobile app. Once the provider-specific application information is entered, the application generation server 108 can generate a binary of the client-side application that can be submitted to the app stores or app marketplaces of the designated platform, such as the APPLE® App Store, GOOGLE PLAY STORE®, HTML5®, and BLACKBERRY® App World. These mobile

Apps may be configured to communicate with the current generation API via the application generation server 106 (or API application servers) to enable features locally and to access the desired features as described herein. In an embodiment, the application generation server 106 may automatically and/or simultaneously update multiple mobile apps to create new versions of the mobile apps, such as when adding additional features to the mobile base app. In an embodiment, the mobile app can be configured to display a specific view to a provider and display a different view to a consumer. In some cases the same mobile app may be configured to enable a provider to have access to certain features of the mobile app while the consumer has access to different features of the mobile app.

In the depicted example, the server computing system 104 may execute the application generation server 108 and the application server 106 to orchestrate the automated application generation process as described herein. Alternatively, the functionality of the application generation server 108 can be distributed over the two or more machines. For example, the server computing system 104 may implement the application generation server 108 and not the application server 106. and another server computing system (not illustrated) can implement the application server 106. Alternatively, other configurations are possible as would be appreciated by one of ordinary skill in the art having the benefit of this disclosure.

In one example, the application server 106 may operate as a server-side API that enables features, allows media uploads and downloads, allows scheduling, and allows payments. The application server 106 may allow a provider to access the data contained in an application description document. The corresponding client-side API may update the configuration when the client-side API is launched if there were any changes as described above.

Regarding media uploads and downloads, the application server 106 may provide endpoints to store and access media uploaded by providers and application users. The uploaded APIs may store the data on an external storage system (e.g., Amazon® s3 service, Akamai® service, etc.) to minimize the cost of storing data and improving the download performance. Alternatively, the application server 106 can store the data in data storage. The media access APIs may provide a list of media and their respective locations, and the mobile app may use this information to display the media.

The following examples describe instances of use cases in which the automated mobile app generator may be used.

In one example, customized features and message capabilities may be enable providers to identify consumers that have registered an account in association with a specific provider via a mobile app. In this example, a mobile app has been created for the specific provider and a consumer has downloaded the mobile app, and a consumer launches the specific provider's mobile app. The consumer may choose to create an account and enters his or her username, password and other personal identifying information via the mobile app. The mobile app may contact the application generation server 108 with the consumer's information. Upon receipt of the consumer's information, the application generation server 108 server may create an account for the consumer and the mobile app may store the consumer's information in secure storage. The mobile app can be notified of the operation's success, and the consumer may receive a message notifying the consumer of the registration's success. As a result, an account is registered for the consumer with a specific provider via the mobile app.

In another example, customized mobile app features and message capabilities may enable a consumer to follow a specific provider on a social network service such as the TWITTER® service. In this example, a mobile app has been created for the specific provider, both the specific provider and the consumer have a social network account such as an account with the TWITTER® service, the consumer has downloaded the mobile app, and the consumer launches the specific provider's mobile app. The consumer may navigate the mobile app to a provider information section and tap on a “Follow on TWITTER®” button. The mobile app may request the consumer's Twitter® credentials and upon verification of the credentials, may contact the TWITTER® server with a follow request. As a result, the consumer now can display and follow the provider on the TWITTER® service.

In another example, customized mobile app features and message capabilities may enable a consumer to display his or her support for a specific provider on a social network such as the FACEBOOK® network. In this example, a mobile app has been created for the specific provider, the both the specific provider and the consumer have a social network account such as an account with the FACEBOOK® service, the consumer has downloaded the mobile app, and the consumer launches the specific provider's mobile app. The consumer may navigate the mobile app to the provider information section and taps on the “Like on FACEBOOK®” button. The mobile app requests the consumer's FACEBOOK® credentials. Upon verification of the consumer's credentials, the mobile app may contact the FACEBOOK server with the like request. As a result, the consumer can “like” a specific provider on the FACEBOOK® service via the mobile app.

In another example, customized mobile app features and message capabilities may enable a consumer to send a specific provider a message. In this example, a mobile app has been created for the specific provider, the consumer has downloaded the mobile app, and the consumer has registered an account with the specific provider. The consumer may launch the mobile app, navigate the mobile app to the provider messages section, and tap on a “New Message” button. The mobile app may present a message composer for the consumer to type a message. When the consumer is finished typing the message, the consumer may tap the send button. The mobile app may submit the message to the processing logic, which may route the message to the specific provider's mailbox. The message may appear in the specific provider's mobile application dashboard and the specific provider may be notified via e-mail that he or she has received a message from the consumer.

The examples described herein illustrate an automated mobile application generator (also referred to herein as a mobile app generator). These mobile apps may be generated for small, medium or large entities, who may be vendors of various products or services.

The method, app and system generates and employs multifunction customer and employee engagement tools to create two way communications links that disseminate information from company to consumer and gather information from consumer to company. The analytics gathered from the engagement centers feedback into a comprehensive business intelligence analytics system.

The DRIVE Business Management System—an integrated mobile reporting tool that includes a management methodology for gathering, reporting and analyzing data in relationship to increases in sales and profitability. It includes 4 modules:
1) DRIVE™ Basic—a customer and employee survey system that is focused on finding out what is important to customers and building customer marketing lists. It generates customizable customer and employee surveys and feeds customer and employee survey intelligence to the DRIVE visual dashboards. The surveys can be deployed on multiple “in store kiosks or “portable survey tablets” in the business; or on the users' personal IPhone, IPad or PC with links from company websites and public social marketing sites (e.g. Facebook or twitter). Customer and employee metrics dashboards can be accessed on the users' personal computers or mobile devices. Users can identify and track actions that will improve the customer and employee experience based on both subjective and objective feedback. The dashboards analyze and convert raw customer and employee data into metrics that can be correlated to probable sales outcomes, such as % of customer spend, dine-out frequency, customer and employee experience and loyalty ratings. The customer surveys include customer list signup that collect emails and phone numbers, and permissions to send offers by text, email or through customer mobile applications.
2) DRIVE™ Plus—a multi-function, customer and employee communication platform focused on building engagement with customers and employees. It generates custom applications that send and receive communications by email, text and through customer and employee engagement mobile applications. The customer and employee engagement applications reside on the users' personal IPhone, iPad or PC or an “in store kiosk or portable tablet”, or a company website. The customer and employee mobile application generator creates a custom branded “web-based” applications without IT expertise or knowledge of programming. Real-time responses to customer survey feedback can be sent to customers with special offers inviting them to return. Real-time responses to employee survey feedback can be sent to employees acknowledging their feedback and confirming requests for management meetings. Graphic content is generated without the requirement for marketing or graphic design expertise. In addition to survey information, customer and employee engagement intelligence is gathered and reported in the visual dashboards. The engagement applications can link out to 3 party applications from the DRIVE platform.
3) DRIVE™ Pro—a reporting tool focused on analyzing marketing effectiveness that includes an algorithm for calculating marketing ROI by analyzing sales lifts in relation to promotion costs. It aggregates metrics from social marketing and other marketing and engagement activities that can be correlated to sales trends. It includes remote access to visual dashboards that organized data based on the frequency of promotions. DRIVE Pro analyzes customer, employee and promotions metrics as leading indicators of financial outcomes to sales and margins.
4) DRIVE™ Enterprise—a system for delivering analytics in a visual and audio format, that is focused on increasing employee productivity. DRIVE Enterprise analyzes financial metrics along with the leading indicators of financial metrics to determine the condition of the company and generate a list of recommended action statements for increasing sales and profitability on a weekly, monthly and quarterly basis. Relevant metrics are delivered to each users' personal computer and mobile device based on their role in the company. Recommended actions can be accepted and tracked, with the option for additional actions to be added by the user. Employee productivity metrics can be linked to a team rewards system. A “business coach avatar” increases employee engagement with technology by personalizing the data through visual and audible interfaces based on user target personas. It generates management text alerts, visual reporting dashboard by role in the company. There is an option to track and cross correlate community and sustainability initiatives data to customer and employee loyalty metrics.

The present invention provides a comprehensive management methodology that cross correlates data between functional areas and relates that data directly to sales and profitability on a weekly, monthly and quarterly basis. To provide generation tools that allows the business owner to quickly and easily generate a multi-function, custom branded customer engagement and engagement communication centers (CC/EC) with tools to update visual content (e.g. coupons and new products) in less than 5 minutes without any IT or web programming experience or access to graphic design software.

To facilitate two way communication between customers and employees and the business. To automatically interface the customer engagement intelligence data to an integrated, custom business analytics back-end with a proprietary management methodology that help business managers to understand their customers, what they expect and how to deliver what they want. This business analytics backend is also custom generated without the need for web programmers or IT support.

Data is received into the Drive Business Management system through integrated API interfaces or manual data entry.

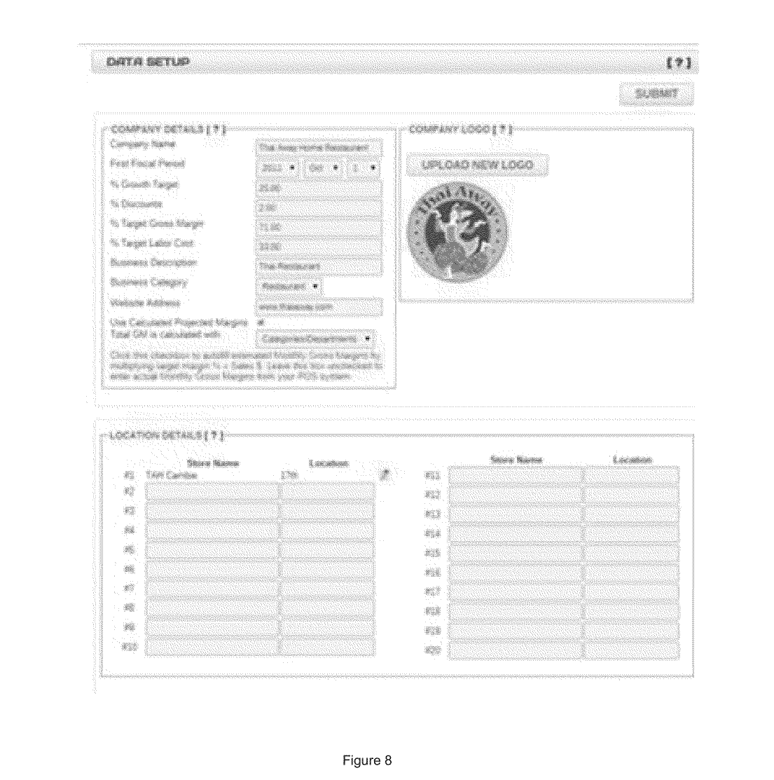

DRIVE™ Management System—Sample Company Setup Screen. Customer can custom brand and customize the management system without a web programmer. Sample setup screen is shown as FIG. 8.

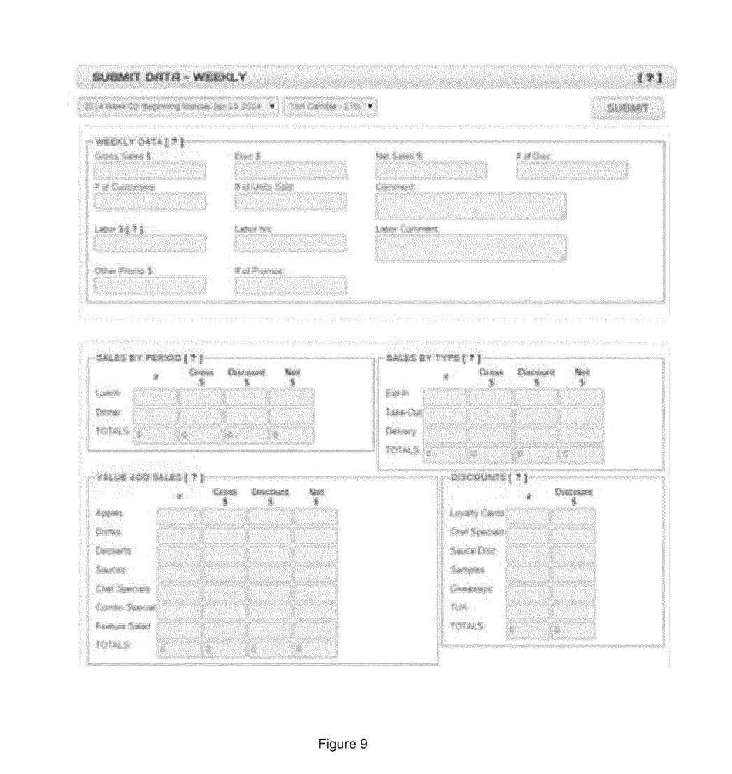

DRIVE™ Management System—Sample Data Input. Sample weekly manual input screen is shown as FIG. 9.

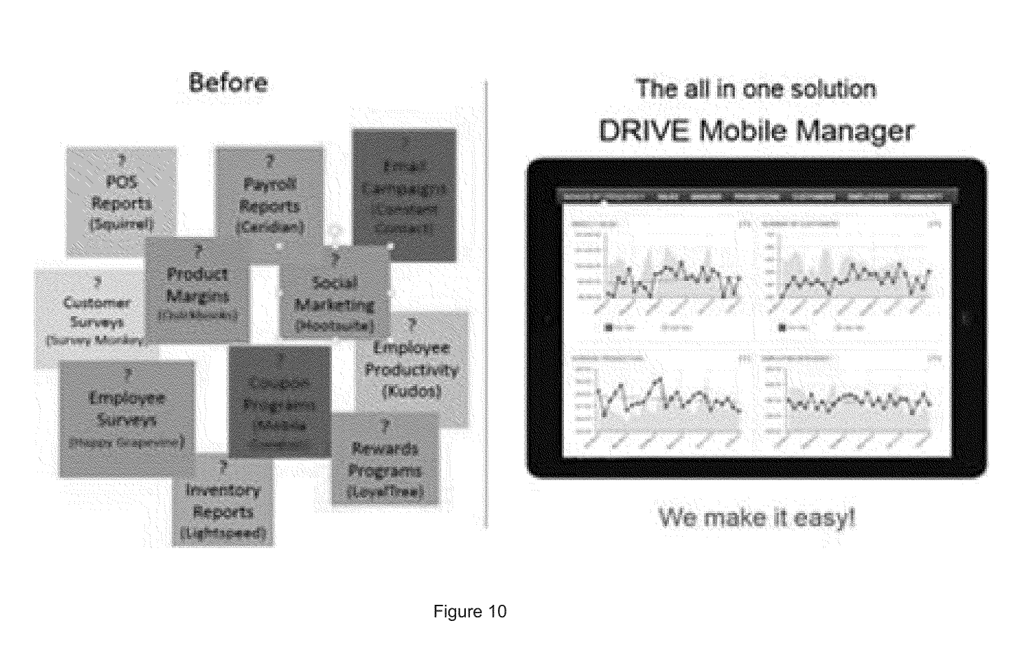

DRIVE Management System—Sample Visual Dashboard Output. Data is reported in a visual format that is organized by frequency of management and by functional areas, as show in FIG. 10.

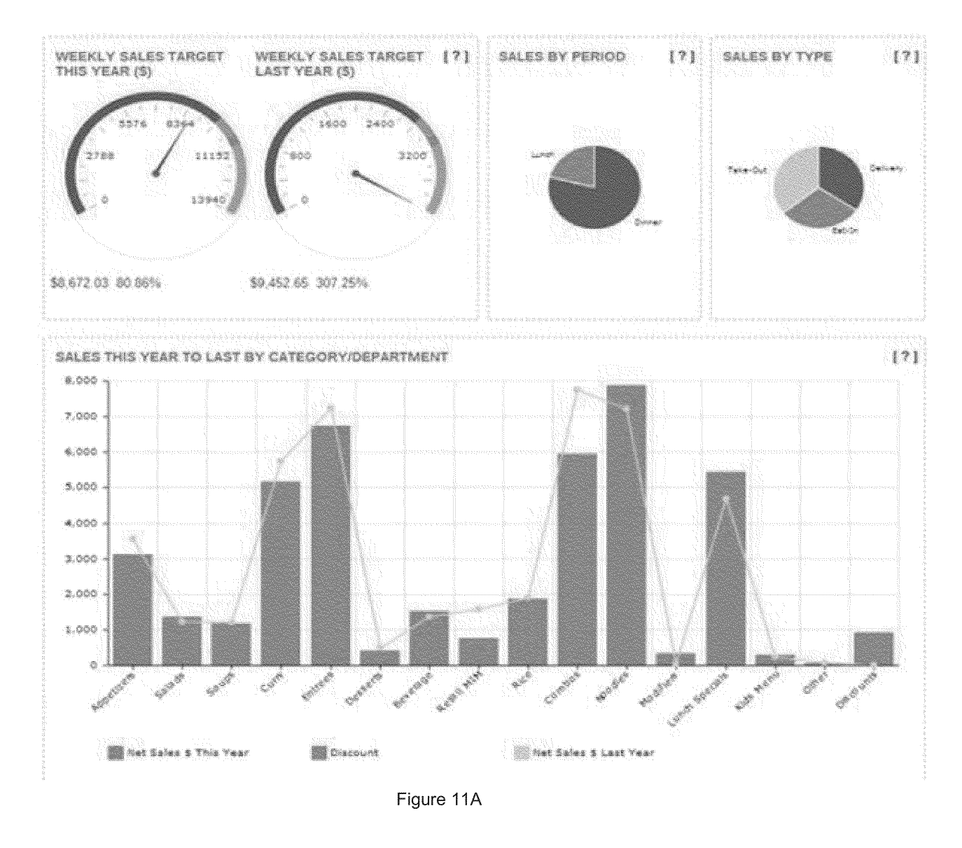

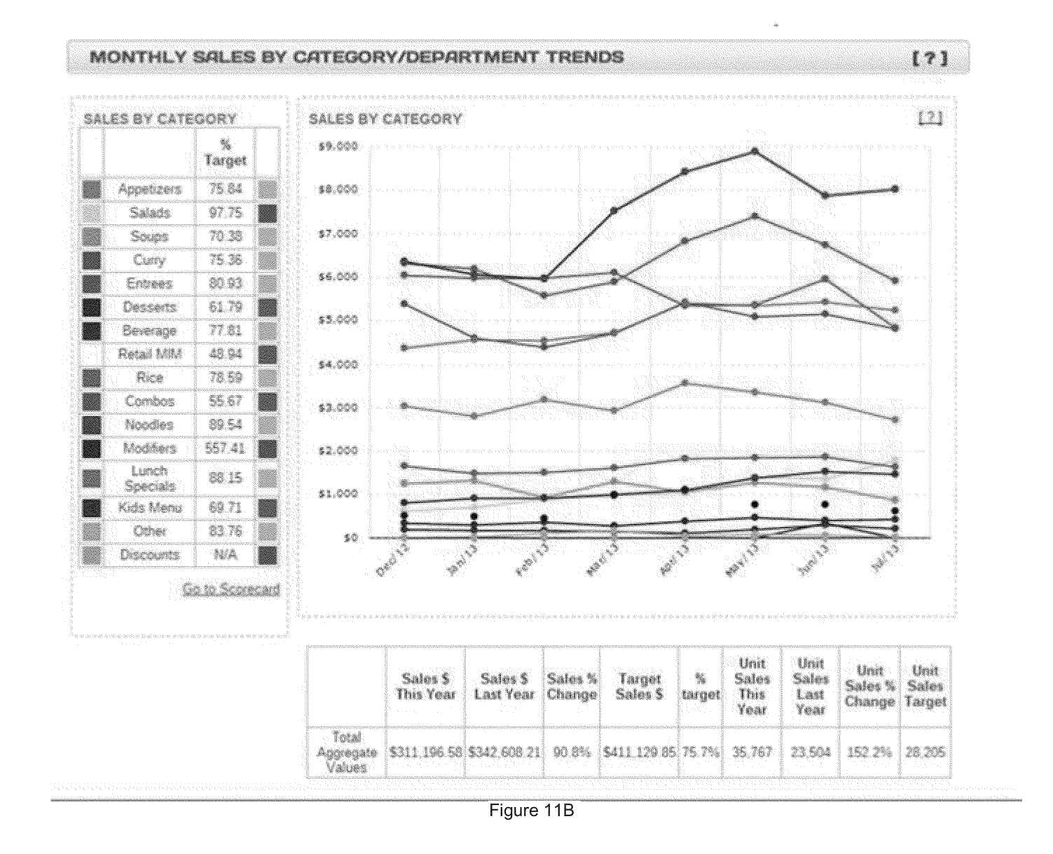

The Data formats include 1) comparative overview snapshots with gas gauge, bar charts and pie charts 2) comparative Trend charts with tables for color coded % of targets with comparative data tables, is shown in FIGS. 11A and 11B.
3) Data scorecards that display the raw data and comparative relationships are shown in Table 1:

MONTHLY SALES BY CATEGORY/DEPARTMENT SCORECARD [?]

| | | | Unit | Gross | % incr/ | | | Net | |
|---|---|---|---|---|---|---|---|---|---|
| Category | | # cust | sales | sales $ | dcr | Disc $ | Disc % | sales $ | Target $ |
| Appetizers | This | 3,001 | 3,001 | $24,739.52 | −0.0% | $0.00 | N/A | $3,125.40 | $32,621.44 |
| | Year | | | | | | | | |
| | Last | 2,227 | 2,227 | $27,184.53 | 100.0% | $0.00 | N/A | $3,552.48 | N/A |
| | Year | | | | | | | | |
| Salads | This | 1,115 | 1,115 | $8769.18 | 17.3% | $0.00 | N/A | $1,359.65 | $8,970.68 |
| | Year | | | | | | | | |
| | Last | 557 | 557 | $7,475.57 | 100.0% | $0.00 | N/A | $1,224.37 | N/A |
| | Year | | | | | | | | |
| Soups | This | 1,210 | 1,210 | $9,161.52 | 15.6% | $0.00 | N/A | $1,178.88 | $15,517.82 |
| | Year | | | | | | | | |
| | Last | 833 | 833 | $10,848.18 | 100.0% | $0.00 | N/A | $1,194.66 | N/A |
| | Year | | | | | | | | |
| Curry | This | 3,334 | 3,334 | $39,599.78 | −9.6% | $0.00 | N/A | $5,166.36 | $52,546.51 |
| | Year | | | | | | | | |
| | Last | 2,550 | 2,550 | $43,788.76 | 100.0% | $0.00 | N/A | $5,738.84 | N/A |
| | Year | | | | | | | | |
| Entrees | This | 3,400 | 3,400 | $50,913.82 | −2.0% | $0.00 | N/A | $6,746.10 | $62,912.30 |
| | Year | | | | | | | | |
| | Last | 2,531 | 2,531 | $52,426.92 | 100.0% | $0.00 | N/A | $7,224.02 | N/A |
| | Year | | | | | | | | |
| Desserts | This | 692 | 692 | $2,935.97 | −25.9% | $0.00 | N/A | $409.27 | $4,751.20 |
| | Year | | | | | | | | |
| | Last | 566 | 566 | $3,959.41 | 100.0% | $0.00 | N/A | $498.98 | N/A |
| | Year | | | | | | | | |

| | | | | | Net | | |
|---|---|---|---|---|---|---|---|
| | | | Gross | | Margin | | |
| Category | | % Target | Margin $ | GM % | $ | NM % | Inven $ |
| Appetizers | This | 75.8% | $29,296.82 | 78.0% | $0.00 | N/A | $0.00 |
| | Year | | | | | | |
| | Last | N/A | $21,203.92 | 78.0% | $0.00 | N/A | $0.00 |
| | Year | | | | | | |
| Salads | This | 97.8% | $ [symbol] .73 | 72.09% | $0.00 | N/A | $0.00 |
| | Year | | | | | | |
| | Last | N/A | $5,449.58 | 72.09% | $0.00 | N/A | $0.00 |
| | Year | | | | | | |
| Soups | This | 70.4% | $6,567.14 | 71.0% | $0.00 | N/A | $0.00 |
| | Year | | | | | | |
| | Last | N/A | $7,799.84 | 71.9% | $0.00 | N/A | $0.00 |
| | Year | | | | | | |
| Curry | This | 75.4% | $24,820.06 | 62.7% | $0.00 | N/A | $0.00 |
| | Year | | | | | | |
| | Last | N/A | $27,455.54 | 62.7% | $0.00 | N/A | $0.00 |
| | Year | | | | | | |
| Entrees | This | 80.0% | $32,992.15 | 64.8% | $0.00 | N/A | $0.00 |
| | Year | | | | | | |
| | Last | N/A | $33,972.65 | 64.8% | $0.00 | N/A | $0.00 |
| | Year | | | | | | |
| Desserts | This | 63.0% | $2,017.01 | 68.7% | $0.00 | N/A | $0.00 |
| | Year | | | | | | |
| | Last | N/A | $2,720.11 | 68.7% | $0.00 | N/A | $0.00 |
| | Year | | | | | | |

[symbol]

indicates data missing or illegible when filed

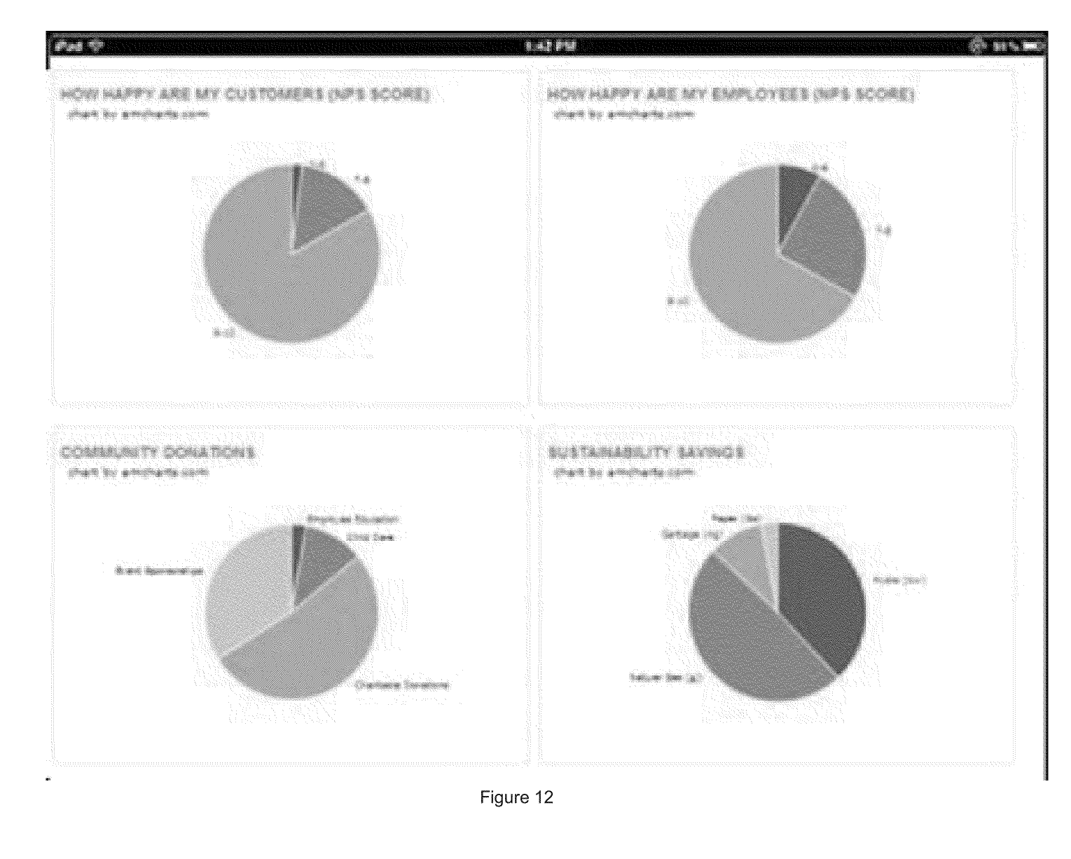

Employee satisfaction metrics are cross correlated to customer satisfaction metrics & community metrics, are shown in FIG. 12.

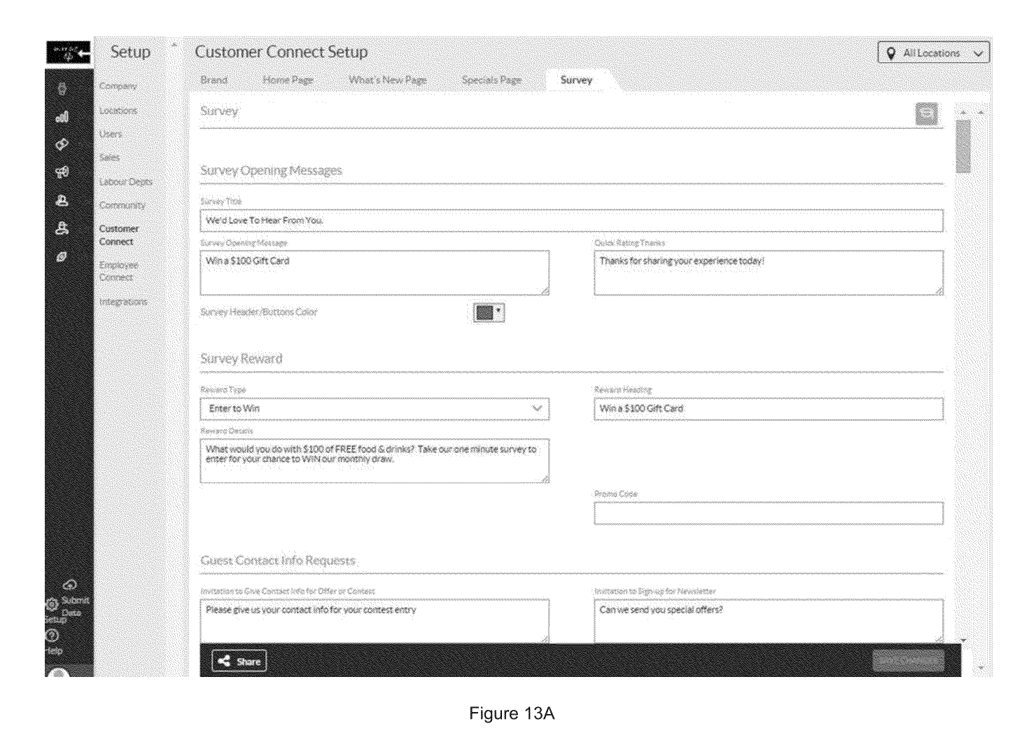

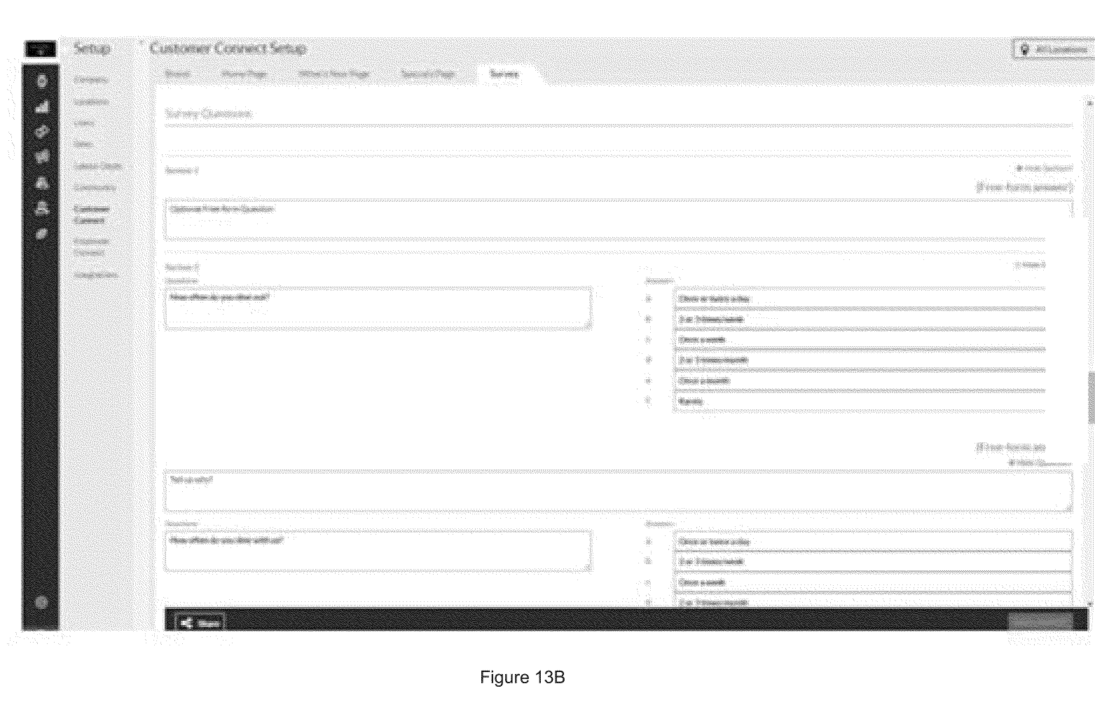

DRIVE™ Management System—Sample Customer Survey Setup Screens, are shown in FIGS. 13A-13B.

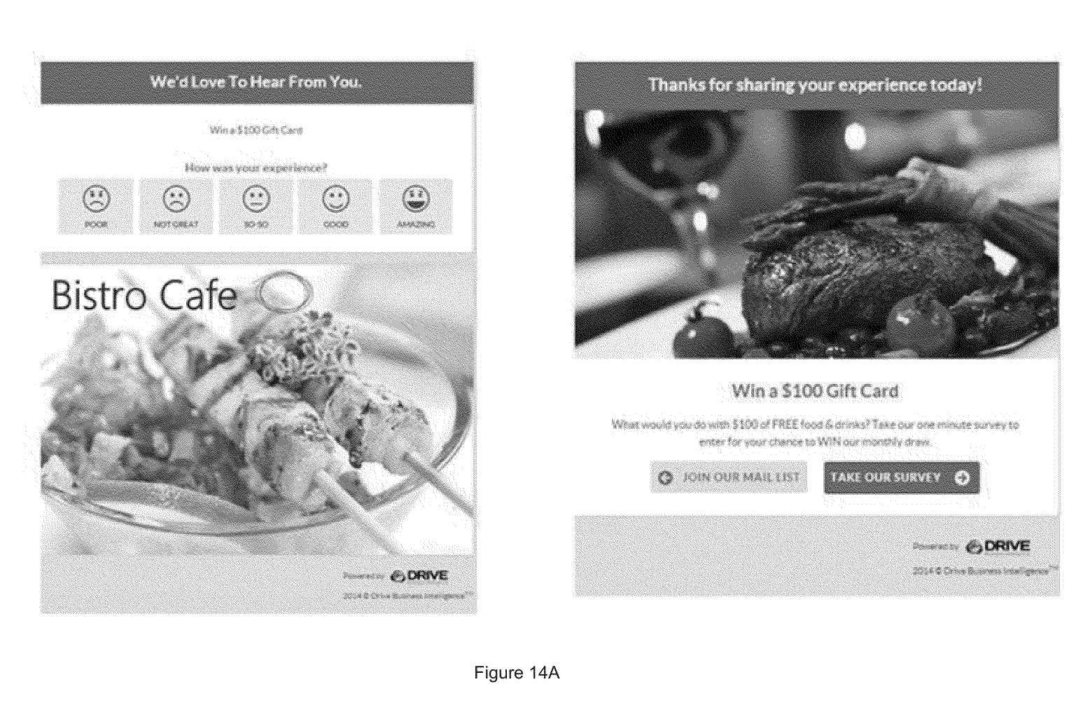

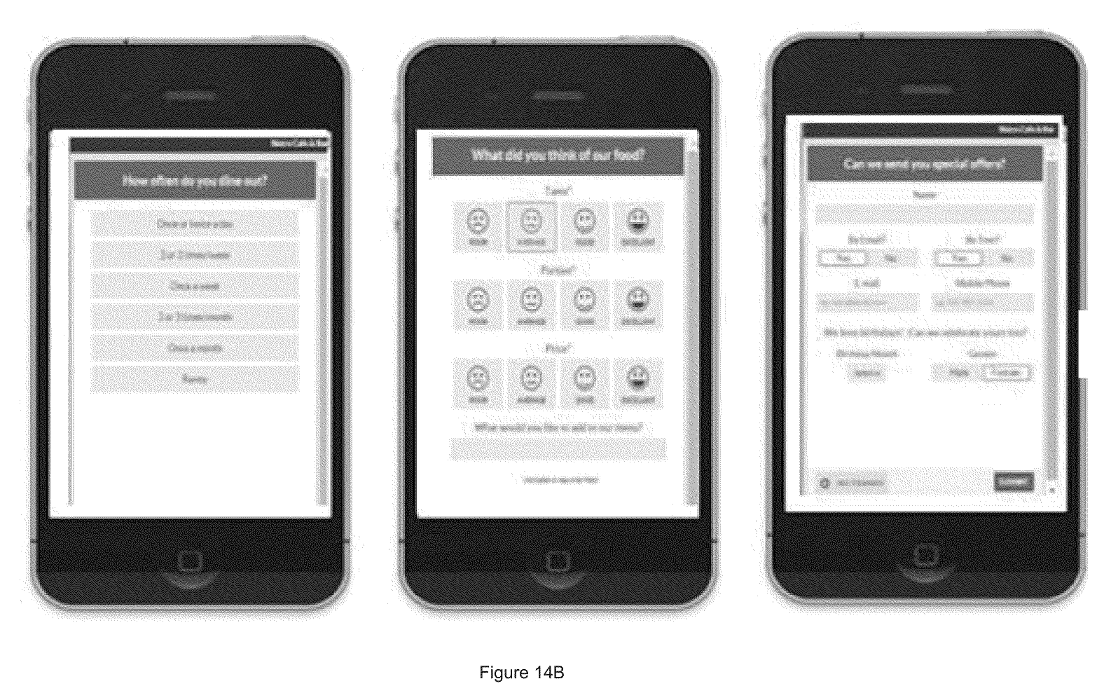

DRIVE™ Management System—Sample Customer Survey, is shown in FIGS. 14A and 14B.

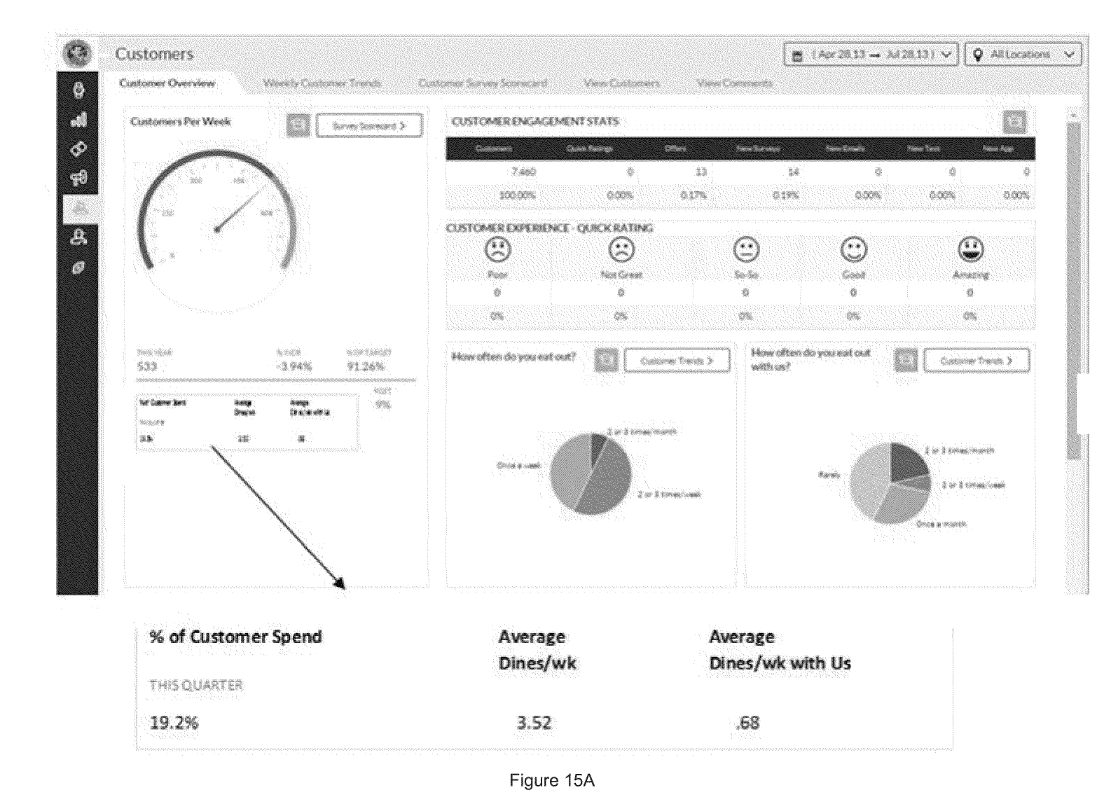

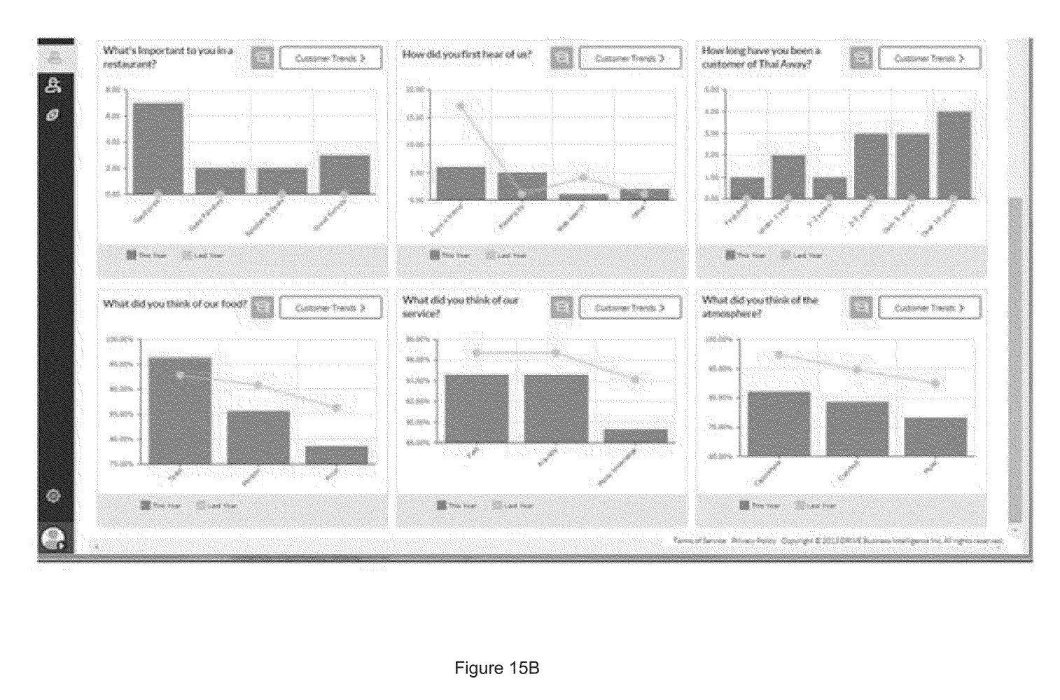

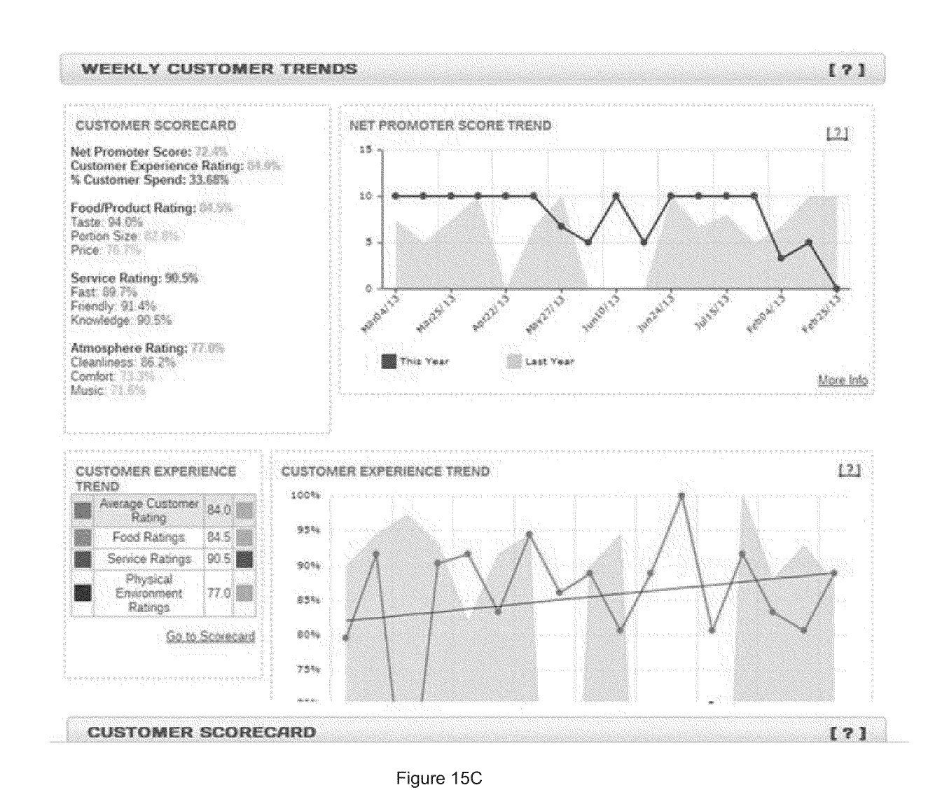

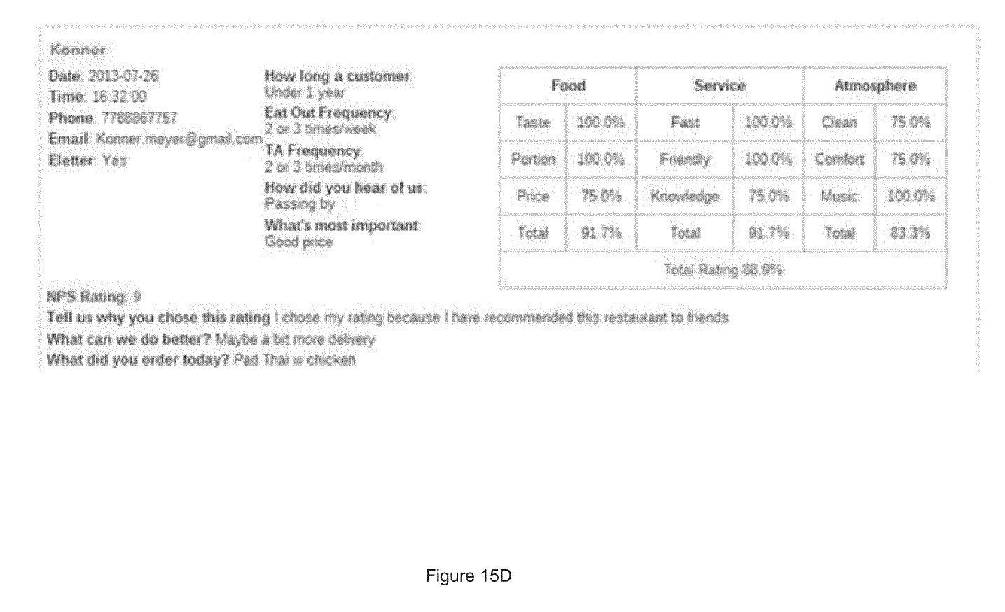

DRIVE™ Management System—Sample Customer Survey Output, is shown in FIGS. 15A, 15B, 15C and 15D.

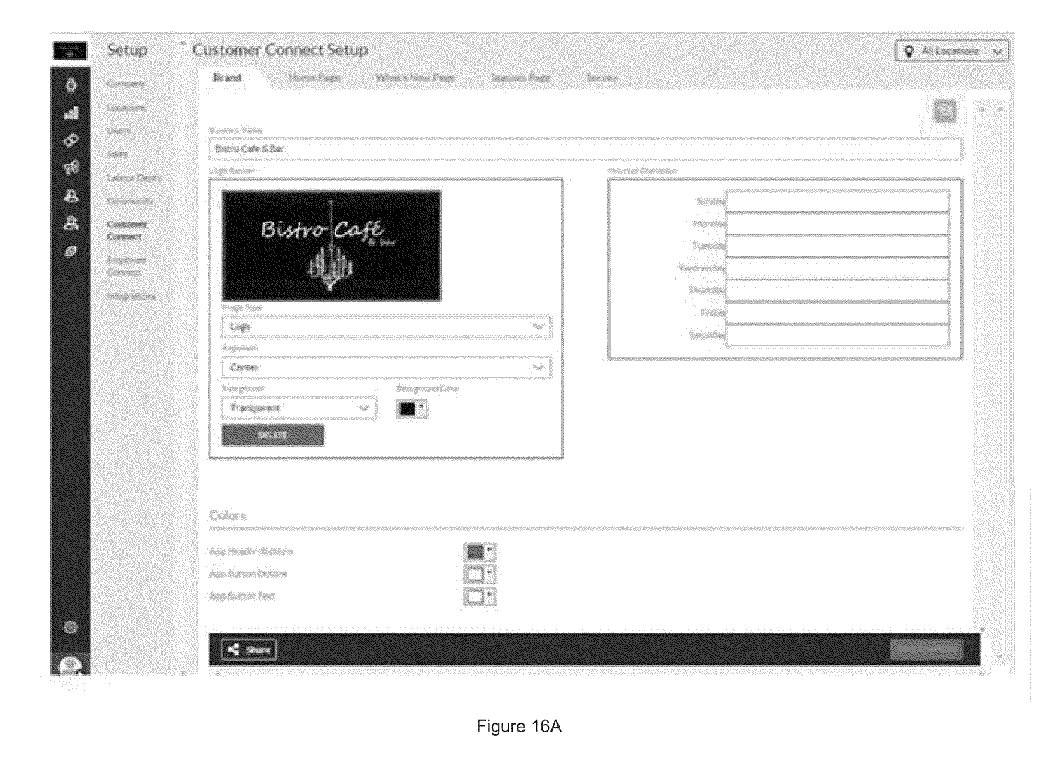

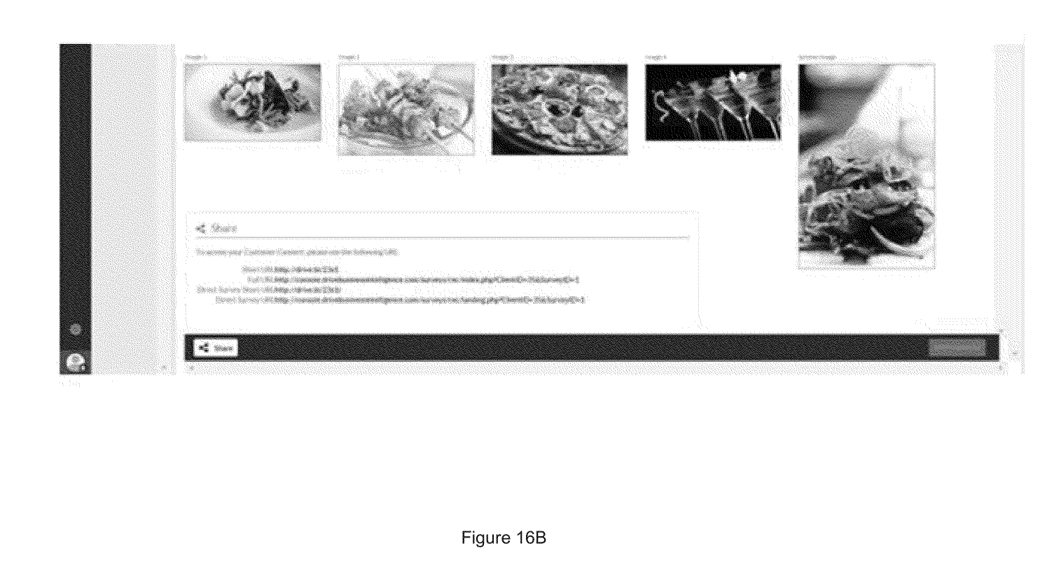

DRIVE™ Management System—Sample Customer Engagement App Setup Screens. The user selects company colours, enters hours and uploads images for their Customer engagement application. A survey and customer engagement link is generated. The same process is used to generate content for product information (e.g. What's New) and special offers (e.g. Promotion Coupons) with promotional tracking codes generated. SMS and email alerts are sent out to the user when new content is posted. SMS and email alerts are sent out to the manager when unfavorable customer reviews are received. Sample set up is shown in FIGS. 16A and 16B.

DRIVE™ Management System—Sample Customer Engagement User Interfaces. The app detects the user choice of the device and formats the screen specific to the device. The user can perform multiple engagement functions with a single user interface.
View “What's new” and give the company feedback on their postings through a thumbs up/down vote
View “special offers” in the form of a coupon with a unique promotion code, that is tracked when redeemed
Give feedback to the company on the customer experience
Click through to an external site to order on-line or browse a menu or catalogue, view rewards programs, gift card repositories, etc.
Quick connect icons for phone calls, maps, hours and review site

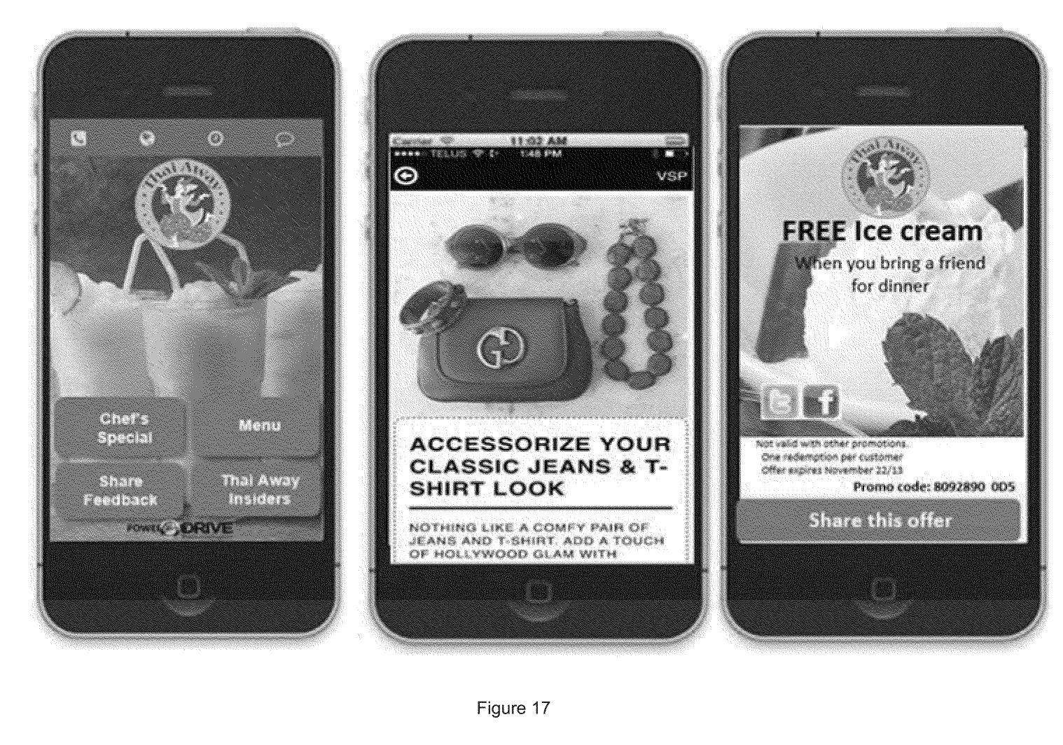

Sample interfaces are shown in FIG. 17.

DRIVE™ Management—Sample Employee Engagement App Setup Screens. The user selects company colours, and uploads images for their employee engagement center. An employee survey and engagement app link is generated. Managers and employees can post to the employee communication board. Employees can view their schedules, enter hours, check rewards points and link to other company sites (eg. job posts, training manuals, etc) SMS and email alerts are sent out to the manager when unfavorable employee reviews or employee request for meetings are received.

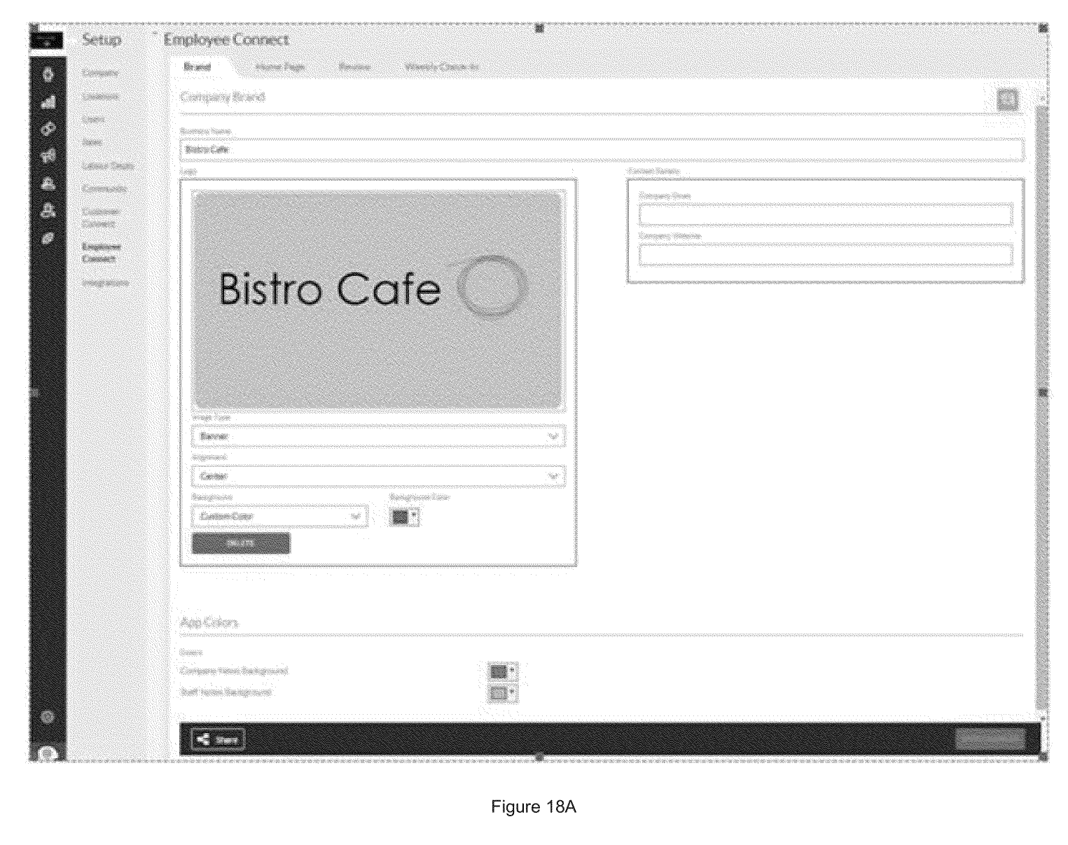

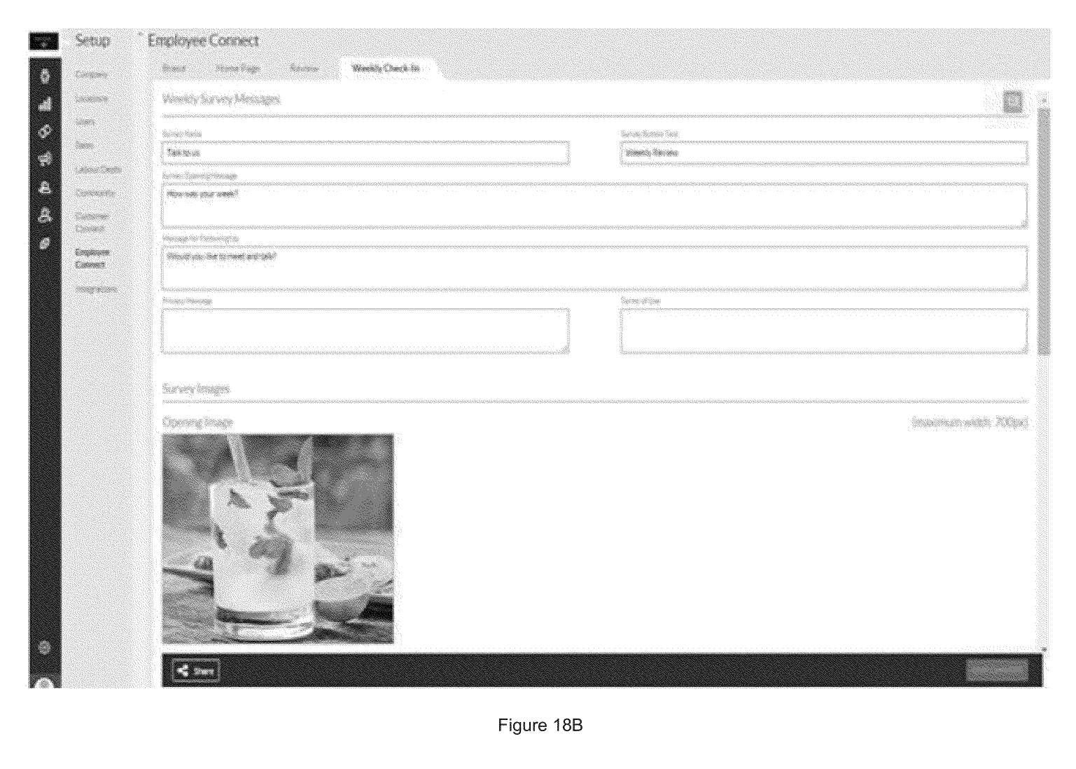

Sample employee interface shown as FIGS. 18A and 18B.

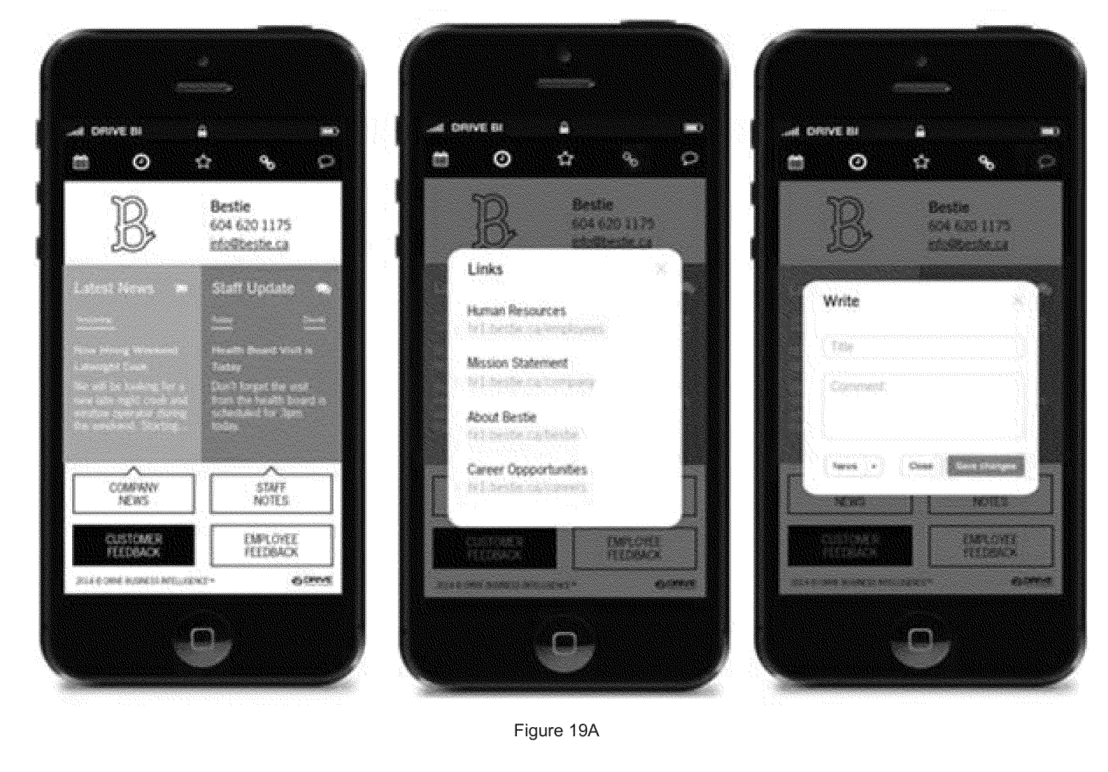

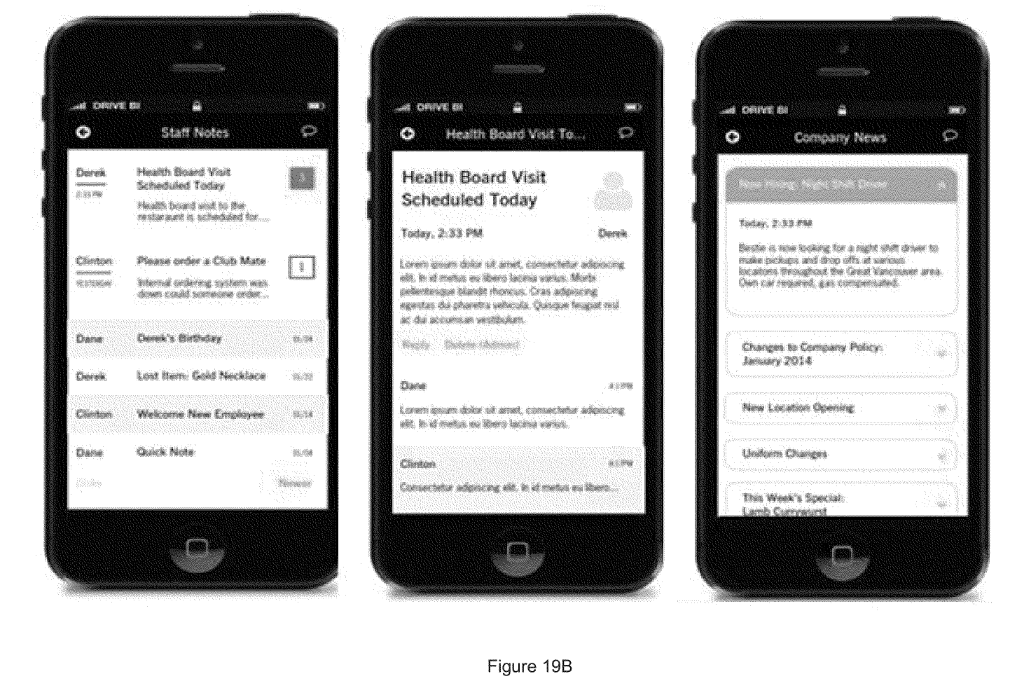

DRIVE™ Management System—Sample Employee Engagement App User Interfaces. The app detects the user choice of the device and formats the screen specific to the device. The user can perform multiple engagement functions with a single user interface. Further employee interface screens on a mobile device shown as FIGS. 19A and 19B.

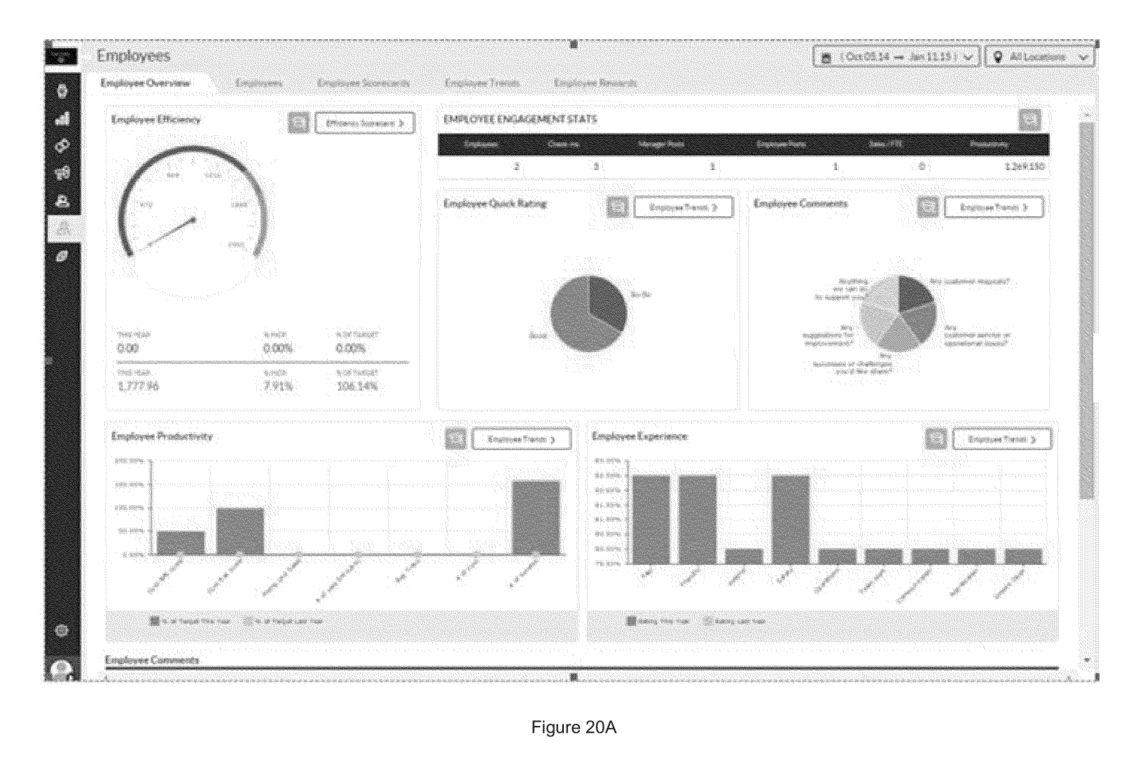

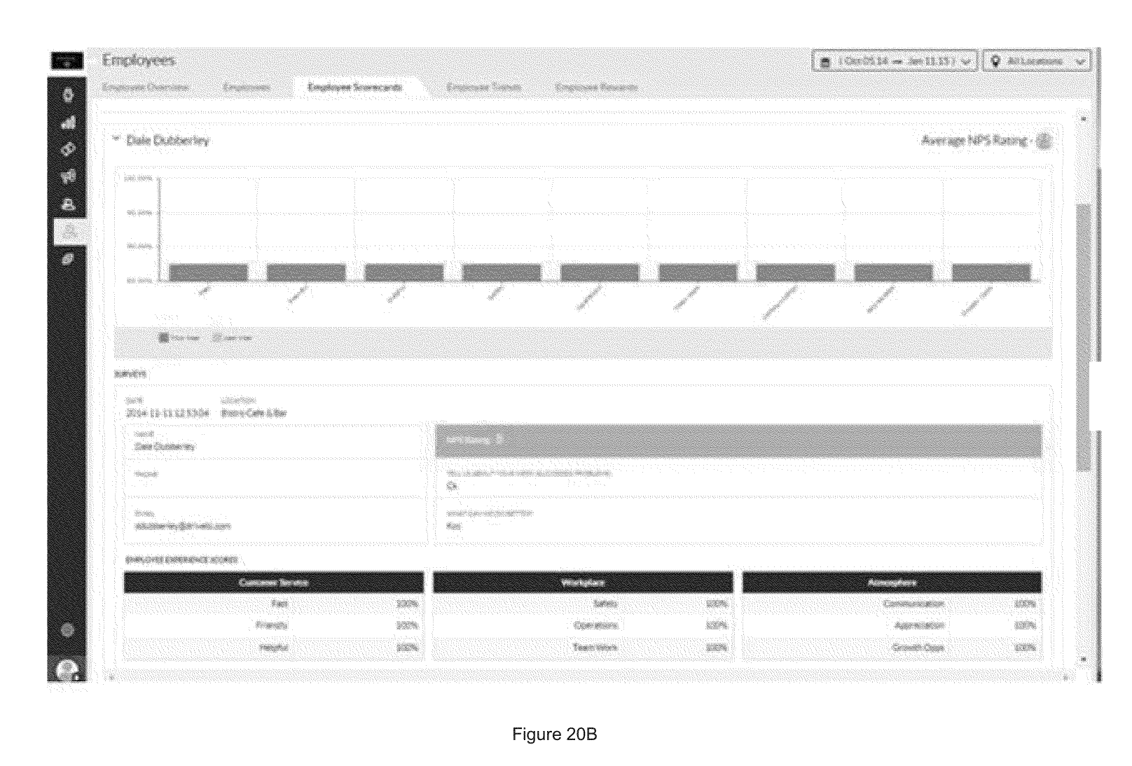

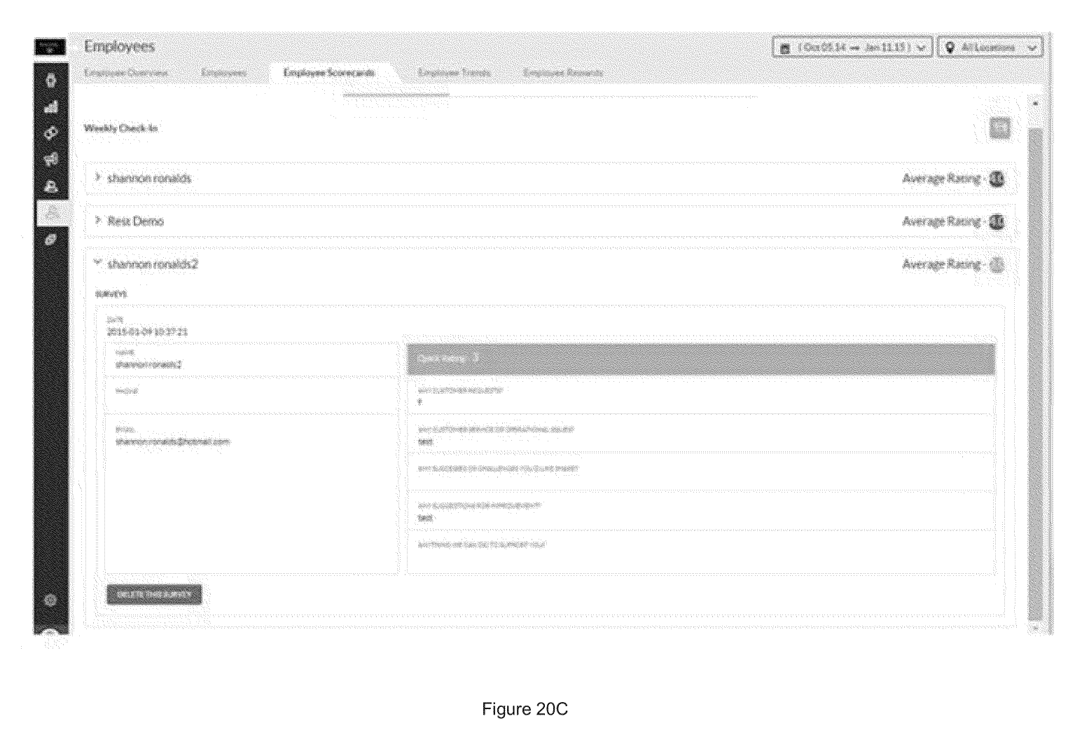

DRIVE™ Management System—Sample Employee Engagement Survey Output. Output to from the employee survey is recorded in an employee scorecard and in management dashboards. Sample employee survey dashboard interface shown as FIGS. 20A, 20B and 20C.

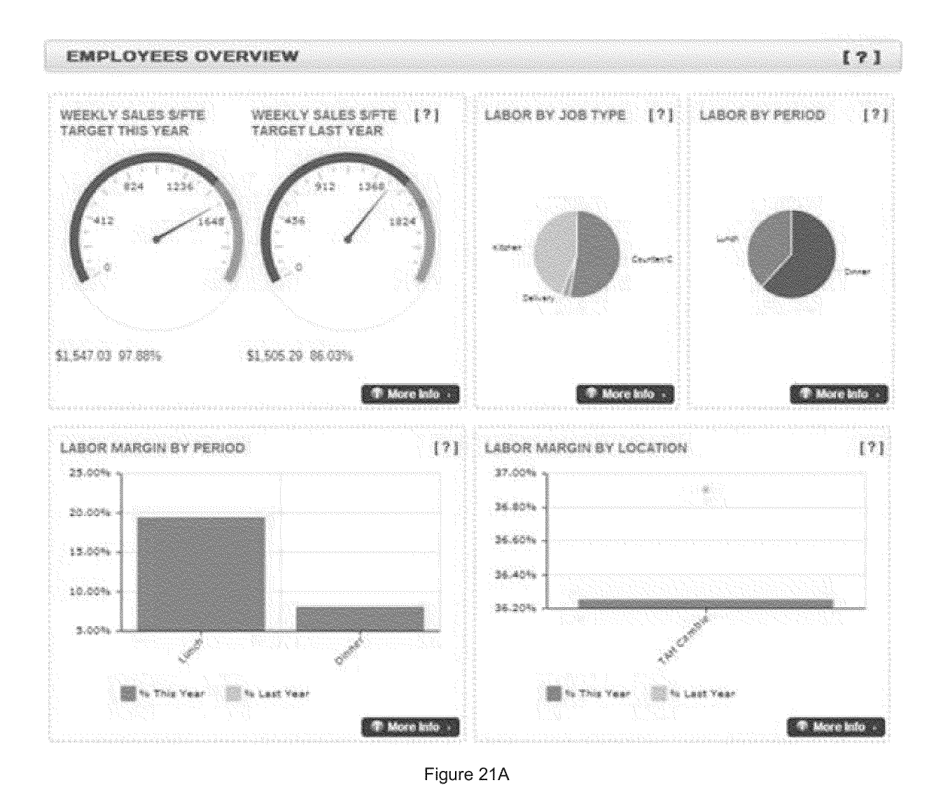

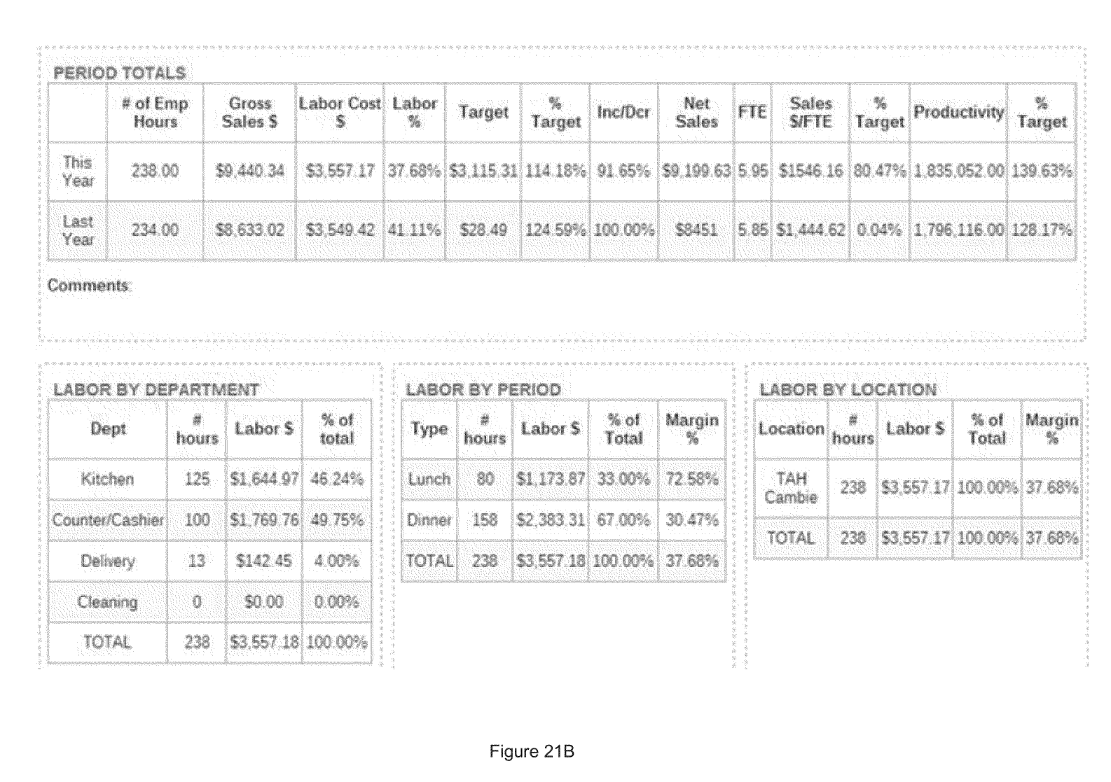

Employee survey metrics are also cross correlated to employee productivity and financial metrics Sample employee overview dashboard interfaces shown as FIGS. 21A and 21B.

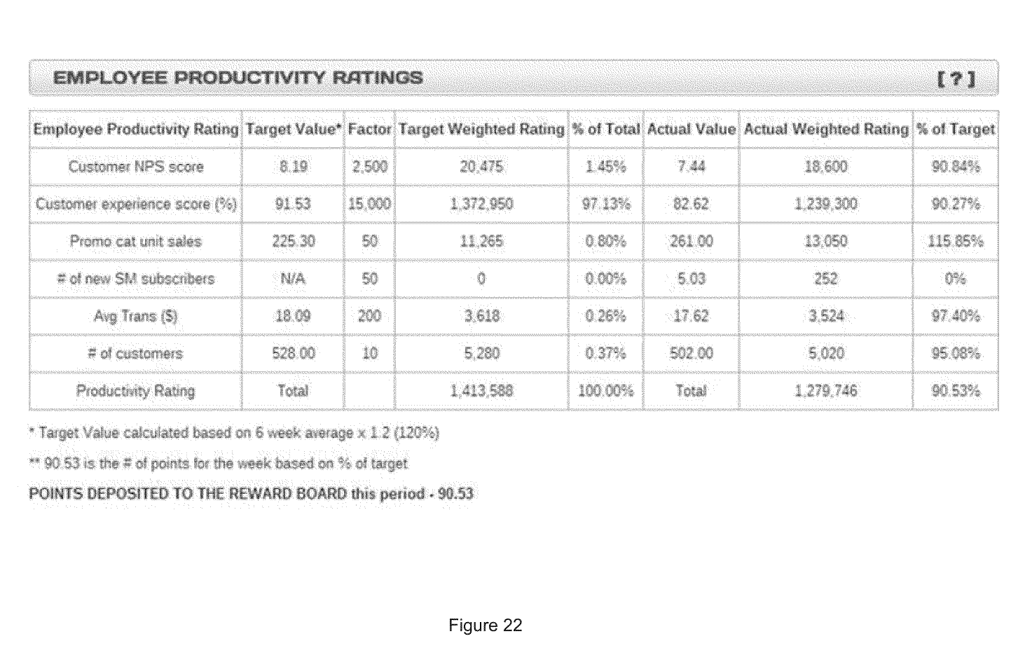

Employee productivity ratings are calculated from customer survey, sales and social marketing metrics. An algorithm is applied to assign relative importance to each metric to derive an employee productivity score. Employee can vote through the employee engagement center on how to spend their points. Sample employee productivity dashboard interface shown as FIG. 22.

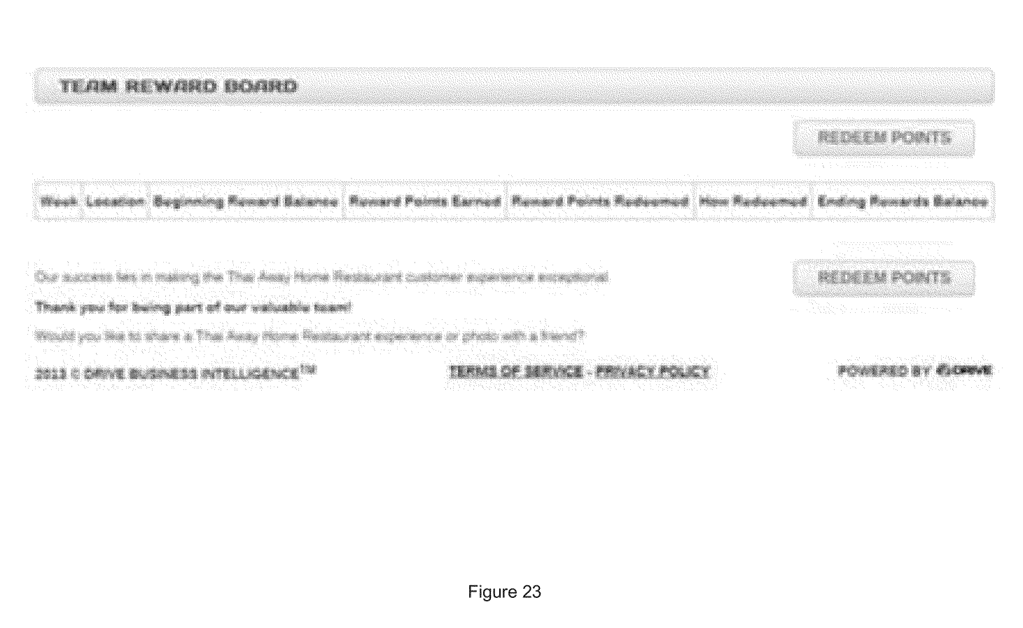

Productivity Points are deposited to a “team reward board” as part of an employee recognition and incentive system. Employees can discuss how to spend their reward board point by posting their ideas to the staff communication board. Sample team reward dashboard interface shown as FIG. 23.

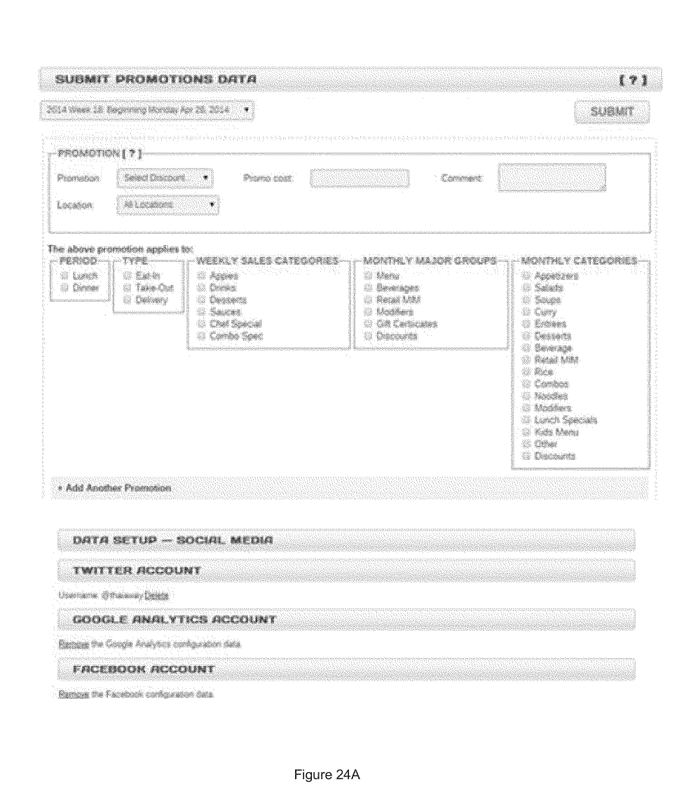

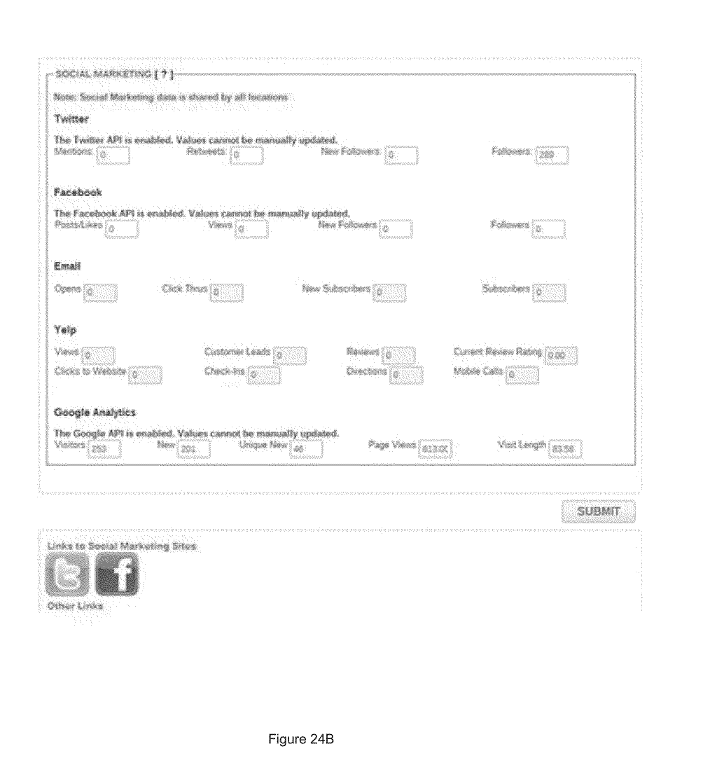

DRIVE™ Management System—Sample Weekly Promotions Input. Social marketing and other marketing actions are captured manually and through API interfaces. Promotions are related to sales periods, type, weekly sales categories, monthly sales groups/vendors and monthly sales categories/departments to determine sales lift and marketing ROI (sales lift/marketing costs). Marketing ROI can be calculated by location and/or as a company metric. Sample promotions data interfaces shown as FIGS. 24A and 24B.

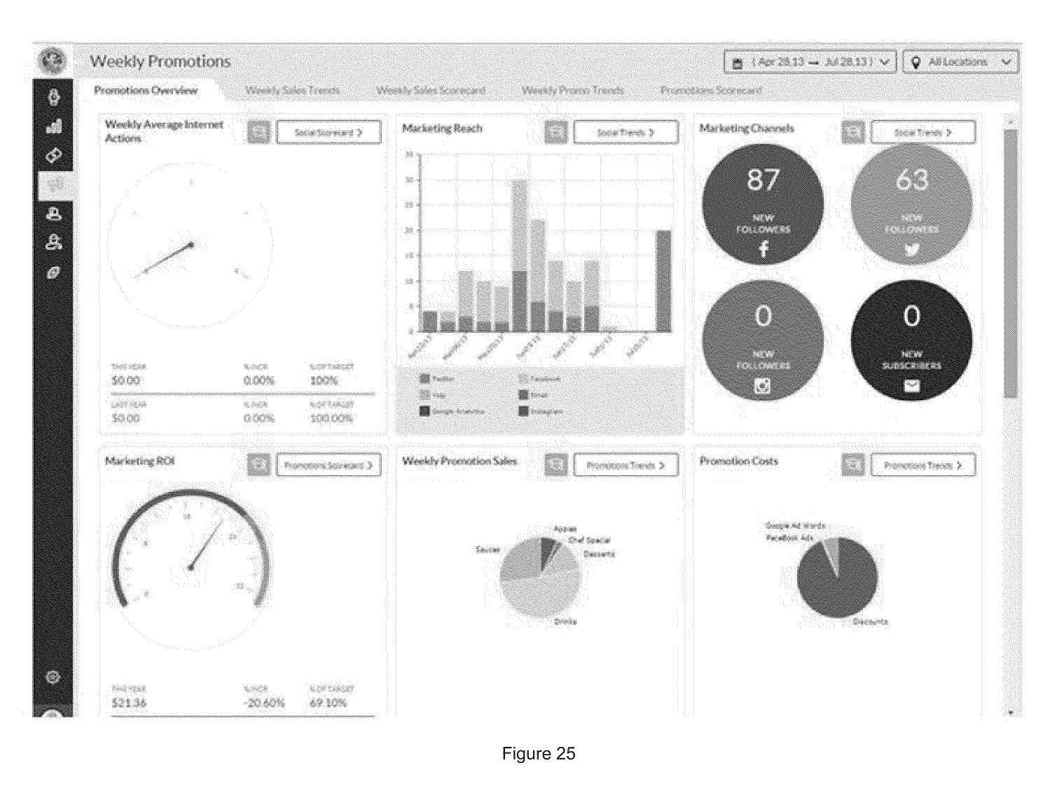

DRIVE™ Management System—Sample Weekly Promotions Output. Promotions data is based on input from social marketing and promotion actions, cross correlated to sales and cost metrics. Gas gauges comparing marketing metrics achieved vs targeted and prior year results are displayed for sales, discounts, promotion costs and average transactions. Social marketing statistics are cross correlated with marketing ROI. Sample weekly promotions dashboard interface shown as FIG. 25.

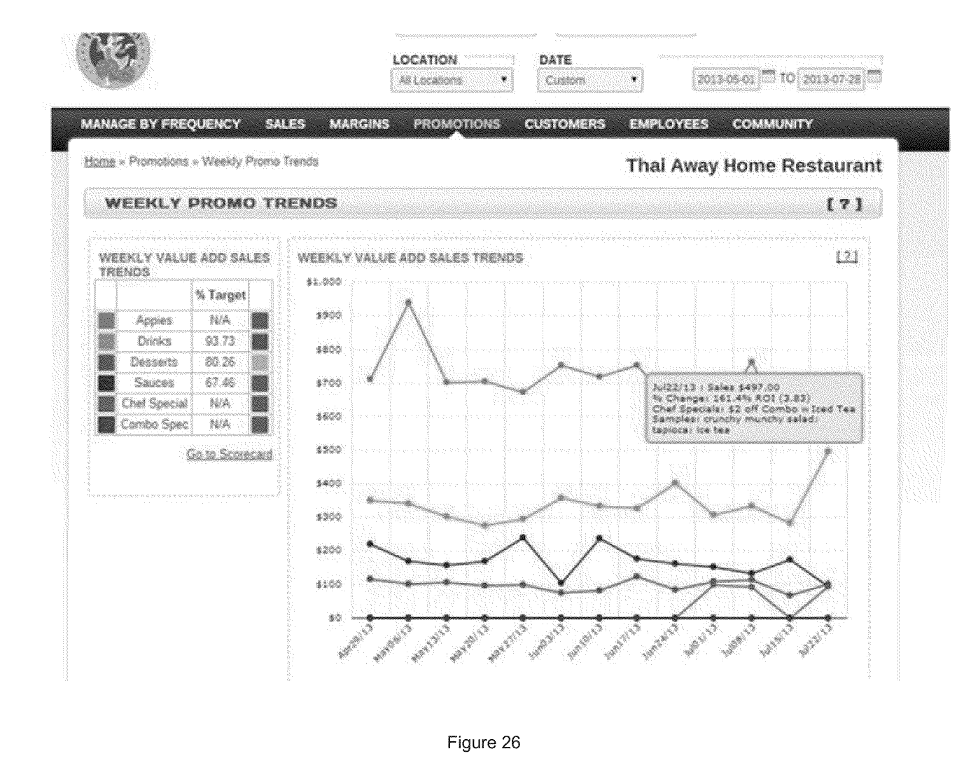

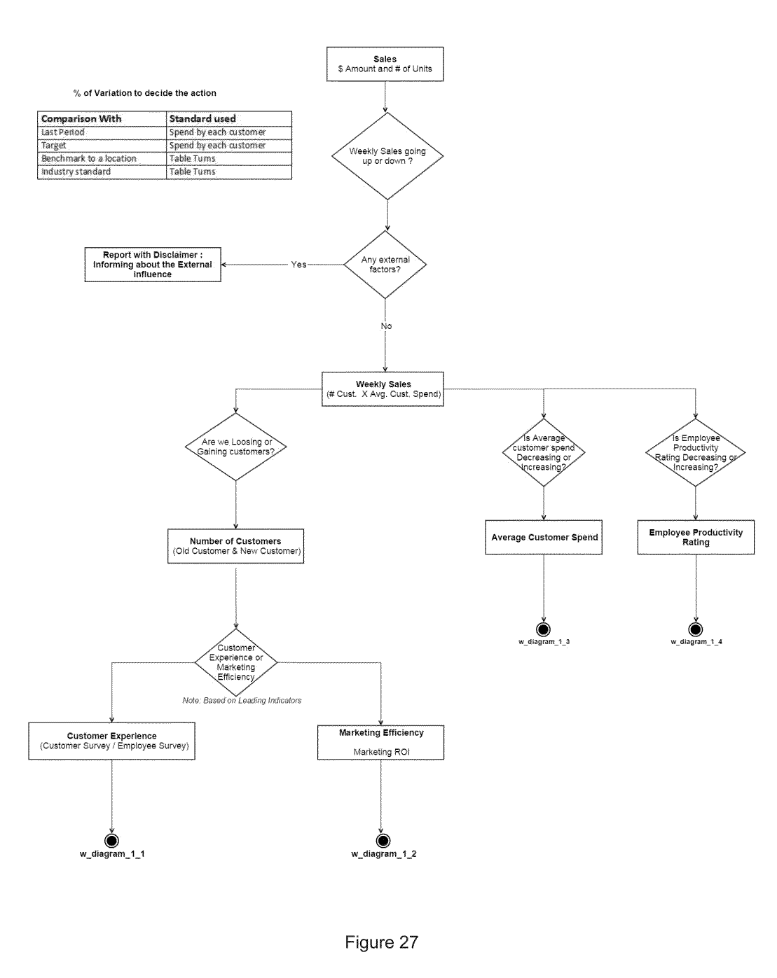

Promotions and marketing actions are cross correlated to sales. A marketing ROI is calculated based on sales lift divided by promotion cost. Sample weekly promo trends dashboard interface shown as FIG. 26.

Promotions outcomes are reported by sales periods, type, weekly sales categories, monthly sales groups/vendors and monthly sales categories/departments. Promotion costs, such as discounts, google ad words and other promotion costs are tracked. Marketing ROI is determined by dividing sales lift by promotion costs. Marketing ROI can be calculated by location and/or as a company metric.

Sample of Drill down from Major Financial Metric through to specific actions.

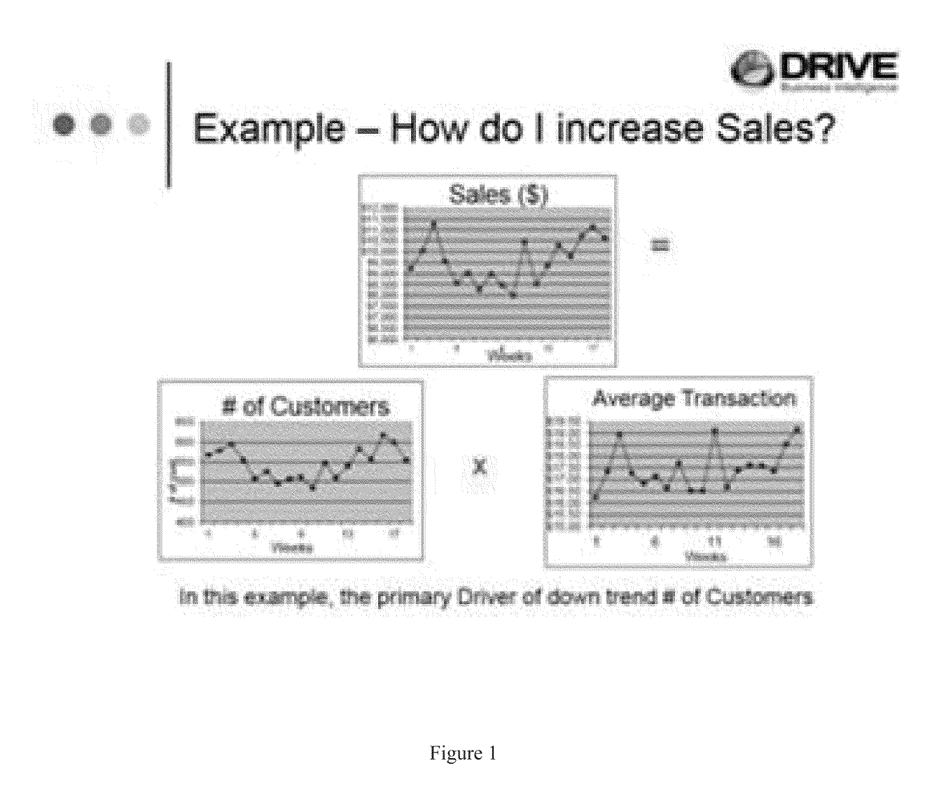

If for example, a business discovers that sales are decreasing, the first step in the drill down is to understand if the sales decline is a result of # of customers or average transaction illustrate in FIG. 1—Primary Driver of # of Sales downtrend is # of Customers.

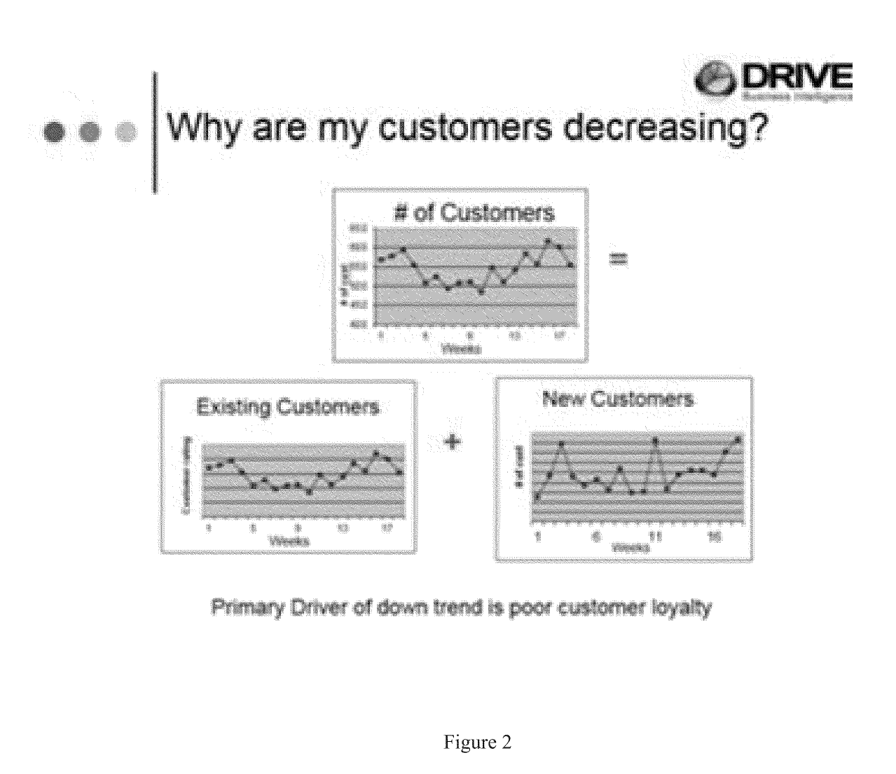

If for example, a business sees that sales is declining, as a result of decreased customers the next step is to examine the components that influence that metric. Examples of drivers that influence # of customer could be the employees, the marketing, the customer experience, etc. It is the system for identifying and understanding the effectiveness of actions through data correlations that lead to changes in financial indicators that make the system and method of this invention highly powerful. If a business discovered that there was a “down trend” in average transaction, then a different drill down path of metrics would be analyzed. By way of example and selecting # of Customers as a drill down path illustrated in FIG. 2—Primary Driver of # of Customers downtrend is Customer Loyalty metric.

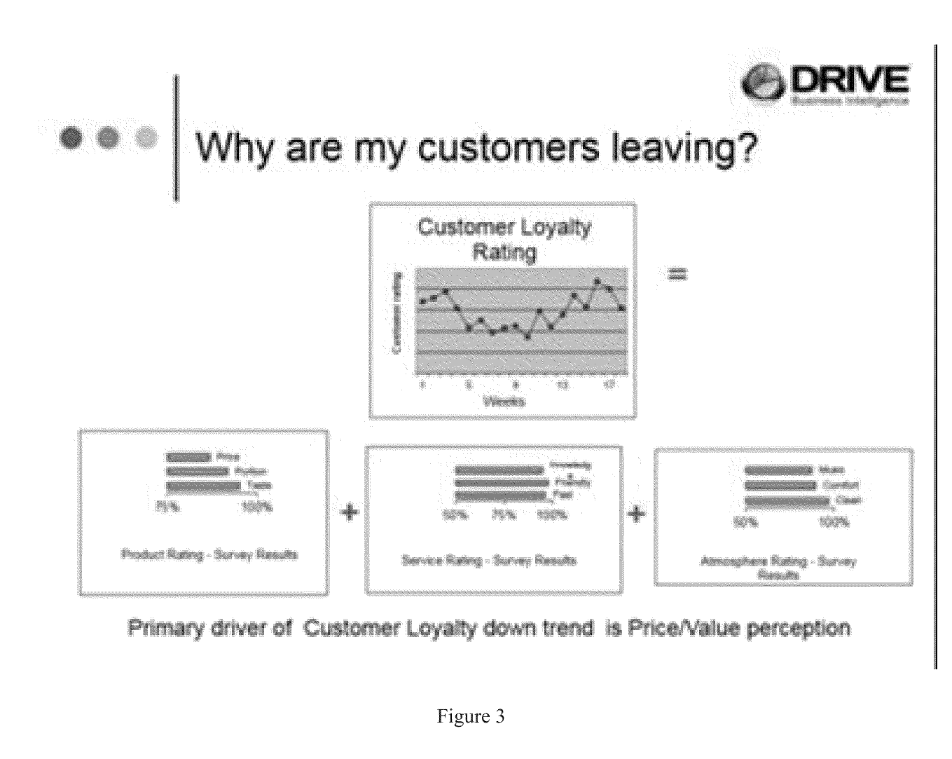

If a business determines that the key metric influencing # of customers is Customer Loyalty, then what are the factors influencing the customer retention and how is the business performing based on those metrics. The customer loyalty rating metrics have a direct correlation to # of customers (e.g. Length of time a customer, frequency of visits to target business vs frequency of visits to competitive businesses, and customer satisfaction ratings). By way of example and selecting Customers Satisfaction as a drill down path. See FIG. 3—Primary Driver of Customers Loyalty downtrend is the Price metric.

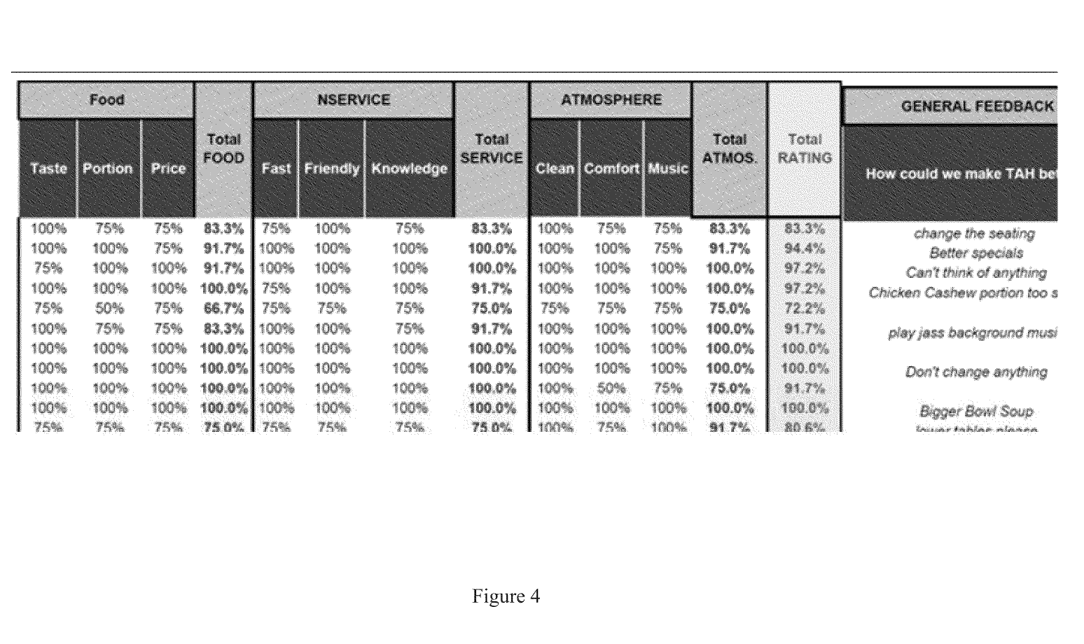

At this point the business needs a direct connect with the customer to understand what specific actions to take. The business would search the customer survey database for poor ratings on price, view the comments and get the customer contact information. From this direct connection with customers regarding a specific metric, the business can understand the specific problem and take remedial action to correct this metric. See FIG. 4 for Customer Loyalty ratings and feedback.

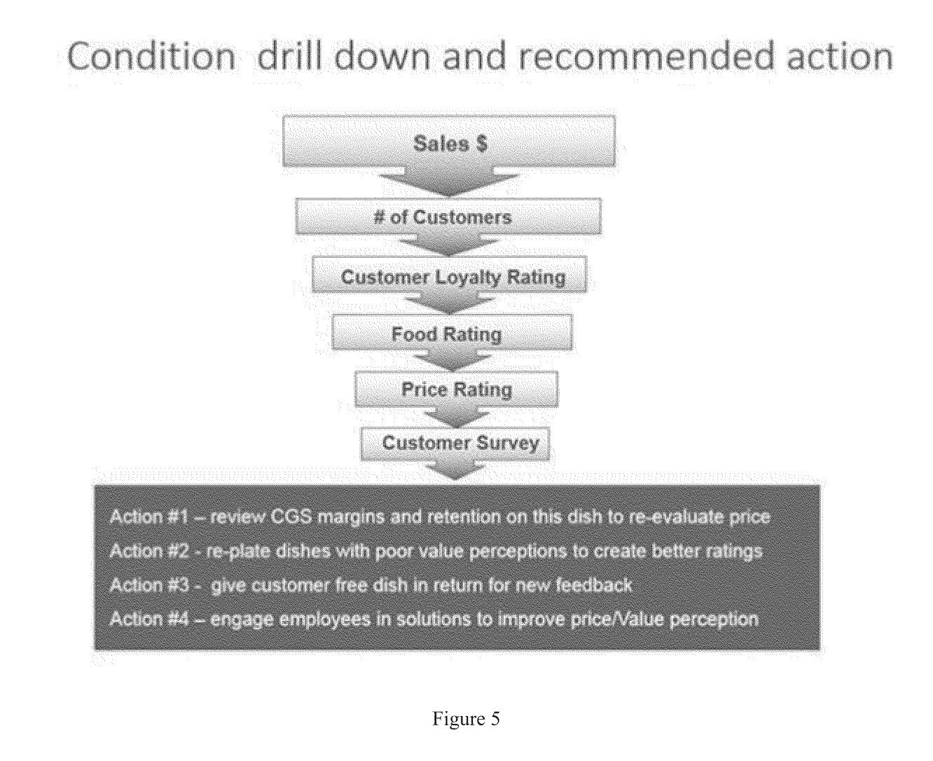

Summary of the above Drill Down Sequence. FIG. 5 is a summary of a sample drill down beginning with sales, and ending with recommended actions, based on the analysis of leading KPI trend lines. FIG. 5—Overview of sample drill down sequence & resulting specific actions. FIG. 29 provides a sample drill down flowchart based on weekly metrics.

Just as the drill down sequence imparts knowledge on what specific action is required in the above chain, so does the completion of the action work in reverse to drive sales up. It is this upward and downward flow that creates the cause and effect relationships for all major metrics. The employees responsible for implementing the actions get immediate feedback on their actions which in turn raises levels of accountability and a sense of empowerment and mastery over their jobs. This in turn creates an increase in employee satisfaction, and increase in customer satisfaction and an amplified increase in sales over and above the sales increase created by the specific action.

The method and system of the invention addresses the challenge of increasing BI adoption by “personalizing” the delivery of BI on a user's (often SME) personal mobile device. As a result of meeting user expectations around ease of access, and a positive user experience, BI consumption levels are thereby pushed up, which increases the success rates of small and medium sized businesses.

The method of the invention applies predictive analysis and artificial intelligence to deliver the KPI and recommended actions each person in the organization can take each week to increase sales. These actions are delivered through a “business coach digital avatar”, like a personal business coach, in both audio and visual formats, according to preferences and the users' role in the company.

A key driver behind the present invention is the need to increase the SME rate of adoption of business intelligence using:

Input: Collected data from a platform comprising KPIs from Sales, Customers, Employees, Marketing and Community Impact and

Analytics and Algorithms: analyzing a common set of KPI across various Lines of Business and Sizes of business for correlations as early indicators of sales performance.

KPI is herein sorted by management frequency (i.e. the timeframe the data becomes reliable and relevant). Each KPI is weighted based on the degree of direct correlation with sales. The weighting system is then tested for variations by LOB and size of business. The target variance and/or weighting for degree of trend line slope is applied in conjunction with the relative correlation of each KPI to sales performance.

Coefficient ratios enable the answering of questions such as, what is the relationship as an early indicator of sales performance between:

Discounts and Net Sales?

Employee and Customer satisfaction?

Customer NPS rating and Customer experience rating?

What is the relationship between social marketing action rates and customer count

The delivery of the KPI is based on the users role in the company weighted according to which KPI they have direct responsibility for, and which have the most immediate impact sales. The weighted KPI can be related to an “urgency of action” that would be associated with a colour and a tone of voice.

Output: A matrix of coefficients by LOB and size of company that combine KPI value×Relative impact on sales×Target variance as a predictor of sales outcomes. A table for each role in the company is created, starting at the employee level, Store Manager, District Manager, Regional Manager, Marketing Manager, HR Manager and Owner/Financial Manager.

These output tables comprise a rating system indicating urgency of action, which preferably are color coded accordingly as red, orange, green and light green. The output table is then used to indicate a company condition and cross referenced to a company solutions statement.

Each KPI weighted table is specific to a role in the company, and is the basis for delivery by target persona. The company condition and recommended solutions are then delivered via a digital media interface (commercially called the “DRIVE Business Coach”). The urgency of action is indicated in the visual dashboard reporting system (commercially called the “Mobile Manager”), preferably with a colour association. It is also used to determine the tone of voice in the digital DRIVE Business Coach avatar on the user's personal mobile device.

In a most preferred form, to deliver business insights through the method and system of the invention, a weighted KPI table is developed for each role in the company (e.g. employee, district manager, regional manager, VP sales, VP HR, etc.) based on the following methodology.
1) Rate the KPI as to the degree of Employee's ability to impact
2) Rate the KPI as the reliability as a leading indicator of SALES performance
3) Rate the KPI current PERFORMANCE (e.g. % of target variance or degree of trend line slope—based on the DRIVE clients actual vs target performance)
4) Multiply EMPLOYEE Weighting factor×SALES IMPACT weighting factor×PERFORMANCE Rating factor (e.g. % incr/dcr or % target)=to get a single Coefficient
5) Sort KPI coefficient ratings highest to lowest to prioritize and assign an urgency of action
6) For each KPI (e.g. # of customers)—assign a “company condition statement” (for example, your customer count is up by 10, 20% above target—Your marketing ROI is 3.83, up 5% from last week) and match it to a “recommended action” statement (Do more promotions similar to last week)
7) Deliver the KPI metric Actual vs Target, a “company condition statement and “recommended action” statement
8) Using the KPI coefficient to assign a color code in the BI visual dashboard and relate to a “tone of voice” (e.g. light green—above 5% of target—enthusiastic; dark green—5% to 5% of target—encouraging;—yellow 5% to—10% of target—tone cautious; red—below 10% of target—serious).

Summary of Drive Business Management System Intellectual Properties.
Definition of the key data indicators of health of the business (metrics—raw data, calculations)
Structure and organization of the data
Definitions of data correlations and data relationships
Visual reporting specifications
Source documents for manual data capture
Web based portal for data collections
Native applications for tablets (LAN or web based)
Generators that create comprehensive, integrated custom business intelligence visual dashboards and reporting systems that can be custom branded and custom tailored to unique business needs.
Generators that create comprehensive, custom branded customer engagement centers and marketing content in approximately 5 minutes without IT support, programmers or graphic artists. The Customer Connect centers have multi-functions in a single user interface that deliver custom backend business analytics management systems to an integrated bi backend. The functions and interfaces include, but are not limited to, GPS locators and business contact links, product development, survey, coupon generation and tracking, rewards programs, and external links to E-commerce systems, or live menus.
Generators that create comprehensive, custom branded employee engagement centers with employee graphical content that can be created in approximately 5 minutes without IT support, programmers or graphic artists. The Employee Connect centers have multi-functions in a single user interface that delver custom backend business analytics management systems to an integrated bi backend. The functions and interfaces include, but are not limited to, company news, employee staff posts, customer feedback reports, employee surveys, employee reward board management and external links to outside scheduling, timesheet and/or payroll systems, websites for training, policies or other company posts.
Employee productivity methods that relate to customer, sales and marketing metrics that feed into an employee productivity and incentive system. Points are accumulated based on the attainment of employee productivity targets and automatically deposited to a “reward board”. The reward board withdrawals are requested by employees through the Employee Connect center.
Proprietary management methods for structuring data files and reports to cross correlate customer and employee metrics with other metrics, such as sales, margins, inventory, social marketing, marketing ROI and community and sustainability metrics that directly lead to increases in sales, profitability, improved financial ratios and long term company viability. The metrics are organized and presented by frequency of management view; weekly, monthly, and quarterly to assist the end user in managing and interpreting and formulating strategies based on the data content.
Generators that create action lists based on analysis of data “this year to last”; “actual vs target”; and as a selected time interval trend (for example, a 6 week trend), that are delivered to a personal device.

The present invention provides an analytics framework which is customizable, by a user, based upon a selected management methodology (as compared to flexible bi, for example, unlimited bi views based on user defined reports). What this means is that the method, app and system of the invention enables an analysis of data that can interpret the condition of the business (for example a company) based on trends and targets. The method enables generation of a “condition statement” for the business (e.g. your Main Street location customer service rating is down in the area of product knowledge) and a “solutions statement” (e.g. recommend a staff training session on product knowledge) that can be delivered on a pre-selected interval, to selected individuals (for example on a weekly basis to the owner or general manager).

The value proposition of the present invention is that if a user owns, for example, 10 locations of a business and each location has 50 metrics, that user would (ideally) need to look at 500 metrics weekly to keep on top of his/her business. The “DRIVE Business Coach” method enables analysis of those 500 metrics over any desired time frame (for example weekly) and enables delivery to an interface of a “hit list” of management actions. Preferably, an interface persona or “avatar” (aka the “DRIVE Business Coach”) delivers these action lists.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, mobile phones, personal digital assistants, smart phones, personal music players (like iPod) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such as those available from Mozilla and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts. As will be apparent to those skilled in the art, the various embodiments described above can be combined to provide further embodiments.

Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer readable medium, other aspects may likewise be so embodied.

The system allows a business owner to get an “at a glance” understanding of which metrics, or drivers of success are failing and would eventually result in a downward trend of a major financial metric. By working this system on a daily/weekly/monthly basis, the driver trends can be turned around before the negative financial impacts are created.

Without the present method and system, it would be financial losses that would be the indicators of action required, and there would be no definitive information to create a strategies solution.

Provided below is an outline of the modules of the Drive Management System:

Drive Business Intelligence Sample Product Features
Management by statistics with trending analysis (trend lines, bar charts, pie charts)
Cloud based visual graphics reporting interface
Definitions of business management metrics with some label customization options
Data correlations for direct cause and effect management of business drivers
Manual Data entry through portal or data capture through other applications (tablet based, POS based, social marketing sources, etc.)
Manual source documents for data organization
Raw data tables with calculated fields and subjective fields (annotations that describe data influencers)
Roll over for user comments & collaborative problem solving
Data assembly from multiple sources & formats (survey software, cash reg, SM statistics)
Drill down by date range
Multiple locations consolidated or independent
This year/last year trending (superimposed)
Dynamic gauges with High/Low ranges
Target Variances
Raw Data drill down on same page as visuals
Tabs for each set of metric
Management notifications based on criteria out of the acceptable range
Potential for multiple frequency of updates in same sheet
Potential for live updates (e.g. Customer survey updates & notifications for immediate response)
Built in documentation—instructions for use.
Seminars, webinars, videos, consulting systems and BI management guides

We claim:

1. A computer-implementable method for a business to collect, track and analyze customer engagement metrics in relation to the business and the drivers of those metrics, to integrate those metrics into a data collection and dashboard reporting system and to enable monitoring of key indicators of health of a business on a periodic basis comprising:
a) acquiring data about a business in respect to at least one of: sales, customer loyalty, number of times customer uses business, number of customer recommendations, length of time customer has used business, sales numbers, number of customers, average transaction size, customer loyalty rating, product rating, service rating and business atmosphere rating (collectively “raw data”);
b) processing, structuring, organizing and analysing the raw data, via a computer system, to generate data correlations and data relationships for the business and to define such data correlations and data relationships; and
c) visually displaying such data correlations and data relationships.

2. A computer-implementable method for a business to collect, track and analyze employee engagement metrics in relation to the business and the drivers of those metrics, to integrate those metrics into a data collection and dashboard reporting system and to enable monitoring of key indicators of health of a business on a periodic basis comprising:
a) acquiring data about a business in respect to at least one of; employee survey metric; employee loyalty rating, customer service rating, workplace rating, support rating, employee productivity and incentive metrics (the “employee raw data”);
b) processing, structuring, organizing and analysing the employee raw data, via a computer system, to generate data correlations and data relationships for the business and to define such data correlations and data relationships; and
c) visually displaying such data correlations and data relationships.

3. A computer-implementable method for collecting and analyzing data and generating recommended actions for a business on a periodic basis comprising:
a) acquiring data, in sets, for the business including at least one of: data of one year to previous year, data on actual vs target, data around a selected time trend (for example 6 week trend), (collectively, the “data sets”);
b) analyzing the condition of the company based on relationships of data in the data sets (“data analysis”);
c) collecting a set of company “condition statements” (for example, at Main Street location, customer service rating is down in the area of “product knowledge”);
d) mapping the data analysis to the set of company “condition statements;
e) mapping the condition statements to one or more recommended action statements (for example, staff training session on product knowledge is recommended); and
f) delivering and visually displaying condition statements and actions statements on a mobile or personal computing device using a personalized “avatar”.

4. A system comprising: one or more processors; a customer engagement system configured to receive, from a plurality of channels, data representing one or more interactions with a customer of a business (customer data); and a correlation module executable by the one or more processors and configured to: determine any secondary characteristics from the customer data; and generate data correlations and data relationships for the business between the customer data and at least one of sales metrics of the business profitability metrics of the business.

5. A system comprising: one or more processors; an employee engagement system configured to receive, from a plurality of channels, data representing one or more interactions with an employee of a business (employee data); and a correlation module executable by the one or more processors and configured to: determine any secondary characteristics from the employee data; and generate data correlations and data relationships for the business between the employee data and at least one of sales metrics of the business profitability metrics of the business.

6. A customer engagement application generator which enables a business user to collect and aggregate a plurality of customer engagement functions in regards to the business comprises at least one text selection module, at least one colour selection module and at least one image upload module. Optionally, the customer engagement application generator comprises of a survey link that can be used independent of the customer engagement application.

7. An apparatus comprising:
a memory; and
a processing device communicably coupled to the memory and to:
receive a request to create a customer engagement application, the request comprising specific application information and specific content for the customer engagement application;
generate a customer engagement application description based on the specific application information, wherein the application description comprises a selection of one or more application features for the customer engagement application;
enable access and use of the customer engagement application by a user on a computing device.

8. An apparatus comprising:
a memory; and
a processing device communicably coupled to the memory and to:
receive a request to create an employee engagement application, the request comprising specific application information and specific content for the employee engagement application;
generate an employee engagement application description based on the specific application information, wherein the application description comprises a selection of one or more application features for the employee engagement application;
enable access and use of the employee engagement application by a user on a computing device.

9. A cloud-based customer engagement platform which receives customer engagement metrics in relation to a business and drivers of those metrics, which integrates those metrics into a data collection and dashboard reporting system, viewable and alterable by the business and which enables monitoring of key indicators of health of the business on a periodic basis, wherein platform:
a) acquires data about a business in respect to at least one of: sales, customer loyalty, number of times customer uses business, number of customer recommendations, length of time customer has used business, sales numbers, number of customers, average transaction size, customer loyalty rating, product rating, service rating and business atmosphere rating (collectively “raw data”);
b) processes, structures, organizes and analyses the raw data to generate data correlations and data relationships for the business and to define such data correlations and data relationships; and
c) visually displays such data correlations and data relationships on the dashboard.

10. A cloud-based employee engagement platform which receives employee engagement metrics in relation to a business and drivers of those metrics, which integrates those metrics into a data collection and dashboard reporting system, viewable and alterable by the business and which enables monitoring of key indicators of health of the business on a periodic basis, wherein platform:
a) acquires data about a business in respect to at least one employee survey metric; (the “employee raw data”);
b) processes, structures, organizes and analyses the employee raw data to generate data correlations and data relationships for the business and to define such data correlations and data relationships; and
c) visually displays such data correlations and data relationships on the dashboard.

11. A method for tracking major financial metrics and the drivers of those metrics, to integrate those metrics into a data collection and dashboard reporting system and to enable monitoring of key indicators of success of a workplace on a periodic basis comprising, comprising the steps of:
a) acquiring at least one real time, continuous, data point set relating to said workplace, which includes data points relating to all activities, roles and functions of a person within a selected time frame, (the “first data point set”);
b) measuring and comparing the first data point set against previously compiled data points from within that same or like workplaces and timeframes (the “comparable data point set”); and
c) utilizing differences and similarities between the first data point set and the comparable data point set to generate data correlations and data relationships for the business and to define such data correlations and data relationships; and
d) visually displaying such data correlations and data relationships.
